(19) United States
(12) Patent Application Publication
(10) Pub. No.: US 2025/0086347 A1
(43) Pub. Date: Mar. 13, 2025

(54) EFFICIENT AND ACCURATE SUBPIXEL SMOOTHING FOR FDTD SIMULATION

(71) Applicant: X Development LLC, Mountain View, CA (US)

(72) Inventors: Brian Adolf, San Mateo, CA (US); Aaditya Chandrasekhar, Madison, WI (US)

(21) Appl. No.: 18/463,983

(22) Filed: Sep. 8, 2023

(51) Int. Cl. G06F 30/20

(52) U.S. Cl. CPC G06F 30/20

(57) ABSTRACT

In some embodiments, a computer-implemented method for simulating performance of a physical device is provided. Calculating a current time step of an operational simulation of the physical device includes, for each voxel of a simulated environment, concurrently with loading a set of field values for the voxel for a previous time step from a main memory, determining permittivity values for the voxel using feature parameter values. The computing system calculates a set of field values for the voxel for the current time step based on the set of field values for the voxel for the previous time step and the permittivity values.

### TECHNICAL FIELD

This disclosure relates generally to inverse design of physical devices, and in particular but not exclusively, relates to inverse design of photonic devices.

### BACKGROUND

Fiber-optic communication is typically employed to transmit information from one place to another via light that has been modulated to carry the information. For example, many telecommunication companies use optical fiber to transmit telephone signals, internet communication, and cable television signals. But the cost of deploying optical fibers for fiber-optic communication may be prohibitive. As such, techniques have been developed to more efficiently use the bandwidth available within a single optical fiber. Wavelength-division multiplexing is one such technique that bundles multiple optical carrier signals onto a single optical fiber using different wavelengths.

### BRIEF SUMMARY

In some embodiments, a non-transitory computer-readable medium having computer-executable instructions stored thereon is provided. The instructions, in response to execution by one or more processors of a computing system, cause the computing system to perform actions for simulating performance of a physical device, the actions comprising: configuring, by the computing system, voxels of a simulated environment to be representative of a set of structural parameters, wherein the set of structural parameters includes a set of features of a first material in an area of a second material, and wherein each feature of the set of features is parameterized by a set of feature parameter values; and performing, by the computing system, an operational simulation of the physical device by calculating a plurality of time steps; wherein calculating a current time step includes, for each voxel of the simulated environment: concurrently with loading, by the computing system, a set of field values for the voxel for a previous time step from a main memory: determining, by the computing system, permittivity values for the voxel using the feature parameter values; calculating, by the computing system, a set of field values for the voxel for the current time step based on the set of field values for the voxel for the previous time step and the permittivity values; and storing, by the computing system, the set of field values for the voxel for the current time step in the main memory; wherein each set of feature parameter values includes a number of features that is smaller than a number of field values in the set of field values for the voxel for the previous time step.

In some embodiments, a computer-implemented method for simulating performance of a physical device is provided. A computing system configures voxels of a simulated environment to be representative of a set of structural parameters. The set of structural parameters includes a set of features of a first material in an area of a second material, and each feature of the set of features is parameterized by a set of feature parameter values. The computing system performs an operational simulation of the physical device by calculating a plurality of time steps. Calculating a current time step includes, for each voxel of the simulated environment: concurrently with loading, by the computing system, a set of field values for the voxel for a previous time step from a main memory: determining, by the computing system, permittivity values for the voxel using the feature parameter values; calculating, by the computing system, a set of field values for the voxel for the current time step based on the set of field values for the voxel for the previous time step and the permittivity values; and storing, by the computing system, the set of field values for the voxel for the current time step in the main memory. Each set of feature parameter values includes a number of features that is smaller than a number of field values in the set of field values for the voxel for the previous time step.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a functional block diagram illustrating a non-limiting example embodiment of a system for optical communication between two optical communication devices via an optical signal, according to various aspects of the present disclosure.

FIG. 2A and FIG. 2B respectively illustrate a non-limiting example embodiment of a demultiplexer and multiplexer, according to various aspects of the present disclosure.

FIG. 2C illustrates a a non-limiting example embodiment of a distinct wavelength channel of a multi-channel optical signal, according to various aspects of the present disclosure.

FIG. 3A-FIG. 3D illustrate different views of a non-limiting example embodiment of a photonic demultiplexer, according to various aspects of the present disclosure.

FIG. 4A and FIG. 4B illustrate a more detailed cross-sectional view of a dispersive region of a non-limiting example embodiment of a photonic demultiplexer, according to various aspects of the present disclosure.

FIG. 5 is a functional block diagram illustrating a non-limiting example embodiment of a system for generating a design of an optoelectronic device, according to various aspects of the present disclosure.

FIG. 6 is a schematic drawing of a memory and processing architecture used by a computing system according to various aspects of the present disclosure

FIG. 7A illustrates a non-limiting example embodiment of a simulated environment describing a photonic device, according to various aspects of the present disclosure.

FIG. 7B illustrates a non-limiting example embodiment of an operational simulation of a photonic device, according to various aspects of the present disclosure.

FIG. 7C illustrates a non-limiting example embodiment of an adjoint simulation within the simulated environment by backpropagating a loss value, according to various aspects of the present disclosure.

FIG. 8A is a flow chart illustrating example time steps for an operational simulation and an adjoint simulation, in accordance with various aspects of the present disclosure.

FIG. 8B is a chart illustrating the relationship between the update operation for the operational simulation and the adjoint simulation (e.g., backpropagation), in accordance with an embodiment of the present disclosure.

FIG. 9 is a schematic illustration of a non-limiting example embodiment of a parameterization of an initial design that uses geometric shape primitives to represent features of the design, according to various aspects of the present disclosure.

FIG. 10 is a flowchart that illustrates a non-limiting example embodiment of a method for generating a design of physical device such as a photonic integrated circuit using geometric shape primitives to represent features of the design, in accordance with various aspects of the present disclosure.

FIG. 11A is a schematic illustration of a non-limiting example embodiment of a set of voxels 1102 that include a curved feature according to various aspects of the present disclosure.

FIG. 11B is a schematic illustration of a boundary voxel that shows sources of inaccuracy with existing subpixel smoothing techniques.

FIG. 12A-FIG. 12C are a flowchart that illustrates a non-limiting example embodiment of a procedure for performing an operational simulation of a simulated environment according to various aspects of the present disclosure.

FIG. 13 is a flowchart that illustrates a non-limiting example embodiment of a procedure for determining effective permittivity values for a voxel according to various aspects of the present disclosure.

### DETAILED DESCRIPTION

Embodiments of techniques for inverse design of physical devices are described herein, in the context of generating designs for optoelectronic devices, photonic integrated circuits (including but not limited to a multi-channel photonic demultiplexer or multiplexer), and/or other types of physical devices that can be simulated using the techniques described below. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Wavelength division multiplexing and its variants (e.g., dense wavelength division multiplexing, coarse wavelength division multiplexing, and the like) take advantage of the bandwidth of optical fibers by bundling multiple optical carrier signals onto a single optical fiber. Once the multiple carrier signals are bundled together, they are transmitted from one place to another over the single optical fiber where they may be demultiplexed to be read out by an optical communication device. However, devices that decouple the carrier signals from one another remain prohibitive in terms of cost, size, and the like.

Moreover, design of photonic devices, such as those used for optical communication, are traditionally designed via conventional techniques sometimes determined through a simple guess and check method or manually-guided grid-search in which a small number of design parameters from pre-determined designs or building blocks are adjusted for suitability to a particular application. However, in actuality, these devices may have design parameters ranging from hundreds all the way to many billions or more, dependent on the device size and functionality. Thus, as functionality of photonic devices increases and manufacturing tolerances improve to allow for smaller device feature sizes, it becomes increasingly important to take full advantage of these improvements via optimized device design.

Described herein are embodiments of a photonic integrated circuit (e.g., a multi-channel photonic demultiplexer and/or multiplexer) having a design obtainable by an inverse design process, and techniques for the design thereof. More specifically, techniques described in embodiments herein utilize gradient-based optimization in combination with first-principle simulations to generate a design from an understanding of the underlying physics that are expected to govern the operation of the photonic integrated circuit. It is appreciated in other embodiments, design optimization of photonic integrated circuits without gradient-based techniques may also be used. Advantageously, embodiments and techniques described herein are not limited to conventional techniques used for design of photonic devices, in which a small number of design parameters for pre-determined building blocks are adjusted based on suitability to a particular application. Rather, the first-principles based designs described herein are not necessarily dependent on human intuition and generally may result in designs which outstrip current state-of-the-art designs in performance, size, robustness, or a combination thereof. Further still, rather than being limited to a small number of design parameters due to conventional techniques, the embodiments and techniques described herein may provide scalable optimization of a nearly unlimited number of design parameters. It will also be appreciated that, though the design and fabrication of photonic integrated circuits is described throughout the present text, similar inverse design techniques may be used to generate designs for other types of physical devices.

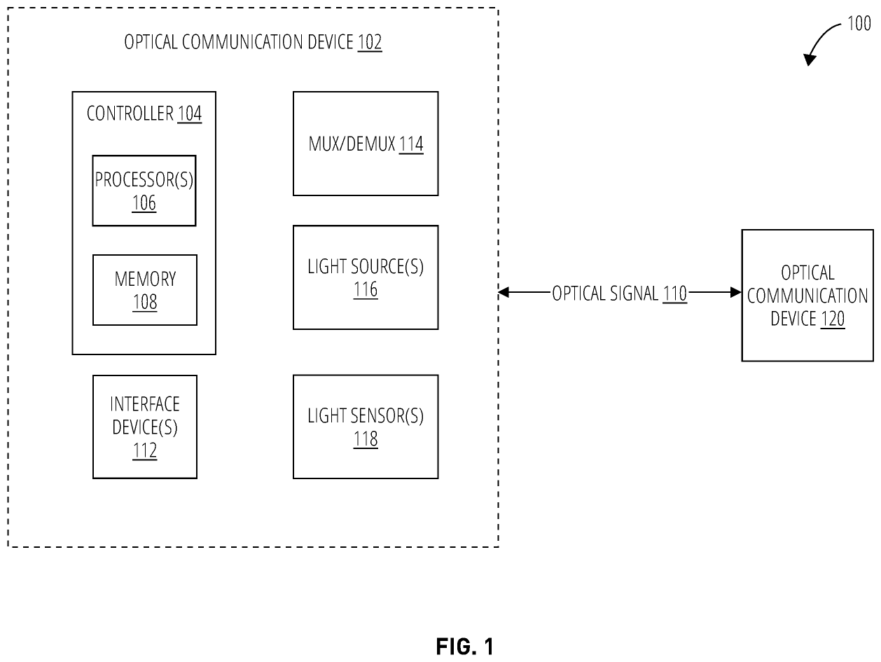

FIG. 1 is a functional block diagram illustrating a system 100 for optical communication (e.g., via wavelength division multiplexing or other techniques) between optical communication device 102 and optical communication device 120 via optical signal 110, in accordance with various aspects of the present disclosure. More generally, optical communication device 102 is configured to transmit information by modulating light from one or more light sources into a multi-channel optical signal 110 (e.g., a singular optical signal that includes a plurality of distinct wavelength channels) that is subsequently transmitted from optical communication device 102 to optical communication device 120 via an optical fiber, a light guide, a wave guide, or other photonic device. Optical communication device 120 receives the multi-channel optical signal 110 and demultiplexes each of the plurality of distinct wavelength channels from the multi-channel optical signal 110 to extract the transmitted information. It is appreciated that in some embodiments optical communication device 102 and optical communication device 120 may be distinct and separate devices (e.g., an optical transceiver or transmitter communicatively coupled via one or more optical fibers to a separate optical transceiver or receiver). However, in other embodiments, optical communication device 102 and optical communication device 120 may be part of a singular component or device (e.g., a smartphone, a tablet, a computer, optical device, or the like). For example, optical communication device 102 and optical communication device 120 may both be constituent components on a monolithic integrated circuit that are coupled to one another via a waveguide that is embedded within the monolithic integrated circuit and is adapted to carry optical signal 110 between optical communication device 102 and optical communication device 120 or otherwise transmit the optical signal between one place and another.

In the illustrated embodiment, optical communication device 102 includes a controller 104, one or more interface device(s) 112 (e.g., fiber optic couplers, light guides, waveguides, and the like), a multiplexer (mux), demultiplexer (demux), or combination thereof (MUX/DEMUX 114), one or more light source(s) 116 (e.g., light emitting diodes, lasers, and the like), and one or more light sensor(s) 118 (e.g., photodiodes, phototransistors, photoresistors, and the like) coupled to one another. The controller includes one or more processor(s) 106 (e.g., one or more central processing units, application specific circuits, field programmable gate arrays, or otherwise) and memory 108 (e.g., volatile memory such as DRAM and SAM, non-volatile memory such as ROM, flash memory, and the like). It is appreciated that optical communication device 120 may include the same or similar elements as optical communication device 102, which have been omitted for clarity.

Controller 104 orchestrates operation of optical communication device 102 for transmitting and/or receiving optical signal 110 (e.g., a multi-channel optical signal having a plurality of distinct wavelength channels or otherwise). Controller 104 includes software (e.g., instructions included in memory 108 coupled to processor 106) and/or hardware logic (e.g., application specific integrated circuits, field-programmable gate arrays, and the like) that when executed by controller 104 causes controller 104 and/or optical communication device 102 to perform operations.

In one embodiment, controller 104 may choreograph operations of optical communication device 102 to cause light source(s) 116 to generate a plurality of distinct wavelength channels that are multiplexed via MUX/DEMUX 114 into a multi-channel optical signal 110 that is subsequently transmitted to optical communication device 120 via interface device 112. In other words, light source(s) 116 may output light having different wavelengths (e.g., 1271 nm, 1291 nm, 1311 nm, 1331 nm, 1506 nm, 1514 nm, 1551 nm, 1571, or otherwise) that may be modulated or pulsed via controller 104 to generate a plurality of distinct wavelength channels representative of information. The plurality of distinct wavelength channels are subsequently combined or otherwise multiplexed via MUX/DEMUX 114 into a multi-channel optical signal 110 that is transmitted to optical communication device 120 via interface device 112. In the same or another embodiment, controller 104 may choreograph operations of optical communication device 102 to cause a plurality of distinct wavelength channels to be demultiplexed via MUX/DEMUX 114 from a multi-channel optical signal 110 that is received via interface device 112 from optical communication device 120.

It is appreciated that in some embodiments certain elements of optical communication device 102 and/or optical communication device 120 may have been omitted to avoid obscuring certain aspects of the disclosure. For example, optical communication device 102 and optical communication device 120 may include amplification circuitry, lenses, or components to facilitate transmitting and receiving optical signal 110. It is further appreciated that in some embodiments optical communication device 102 and/or optical communication device 120 may not necessarily include all elements illustrated in FIG. 1. For example, in one embodiment optical communication device 102 and/or optical communication device 120 are passive devices that operate as an intermediary device that may passively multiplex a plurality of distinct wavelength channels into a multi-channel optical signal 110 and/or demultiplex a plurality of distinct wavelength channels from a multi-channel optical signal 110.

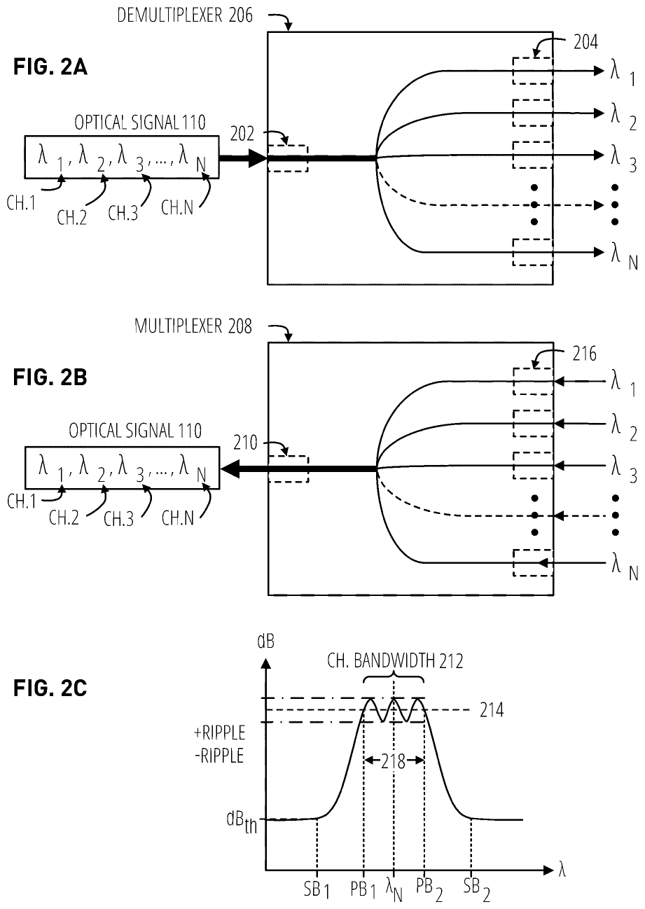

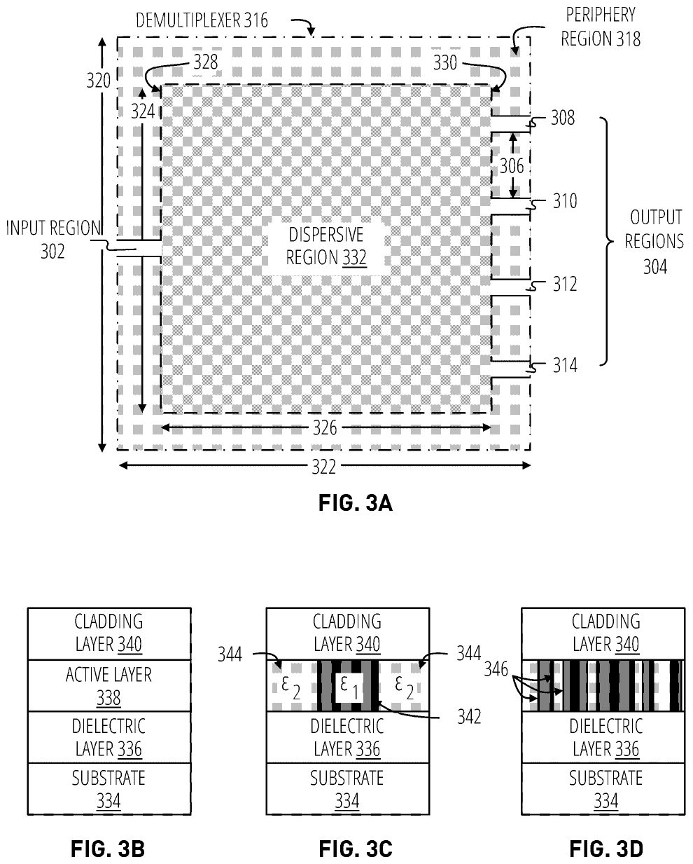

FIG. 2A and FIG. 2B respectively illustrate an example demultiplexer 206 and multiplexer 208, in accordance with various aspects of the present disclosure. Demultiplexer 206 and multiplexer 208 are possible embodiments of MUX/DEMUX 114 illustrated in FIG. 1, and which may be part of an integrated photonic circuit, silicon photonic device, or otherwise

As illustrated in FIG. 2A, demultiplexer 206 includes an input region 202 and a plurality of output regions 204. Demultiplexer 206 is configured to receive a multi-channel optical signal 110 that includes a plurality of distinct wavelength channels (e.g., Ch. 1, Ch. 2, Ch. 3, . . . . Ch. N, each having a center wavelength respectively corresponding to λ₁, λ₂, λ₃, . . . λ_{N}) via input region 202 (e.g., a waveguide that may correspond to interface device 112 illustrated in FIG. 1) to optically separate each of the plurality of distinct wavelength channels from the multi-channel optical signal 110 and respectively guide each of the plurality of distinct wavelength channels to a corresponding one of a plurality of output regions 204 (e.g., a plurality of waveguides that may correspond to interface device(s) 112 illustrated in FIG. 1). More specifically, in the illustrated embodiment, each of the output regions 204 receives a portion of the multi-channel optical signal that corresponds to, or is otherwise representative of, one of the plurality of distinct wavelength channels that may be output as plurality of optical signals (e.g., λ₁, λ₂, λ₃, . . . λ_{N}). The plurality of output regions 204 may each be coupled to a respective light sensor (e.g., corresponding to light sensor(s) 118 illustrated in FIG. 1), which may be utilized to convert the optical signals demultiplexed from the multi-channel optical signal 110 into electrical signals for further processing.

In the illustrated embodiment of FIG. 2B, multiplexer 208 includes a plurality of input regions 216 and an output region 210. Multiplexer 208 is configured to receive a plurality of distinct optical signals (e.g., λ₁, λ₂, λ₃, . . . λ_{N}), each at a respective one of the plurality of input regions 216 (e.g., a plurality of waveguides that may correspond to interface device(s) 112 illustrated in FIG. 1). Multiplexer 208 is structured or otherwise configured to optically combine (i.e., multiplex) each of the plurality of distinct wavelength channels into a multi-channel optical signal 110 that is guided to output region 210 (e.g., a waveguide that may correspond to interface device 112 illustrated in FIG. 1). It is appreciated that in some embodiments, demultiplexer 206 illustrated in FIG. 2A and multiplexer 208 illustrated in FIG. 2B may be bidirectional such that each device may function as both a demultiplexer and multiplexer.

FIG. 2C illustrates an example distinct wavelength channel of a multi-channel optical signal (e.g., Ch. N is multi-channel optical signal 110 illustrated in FIG. 1, FIG. 2A, and FIG. 2B), in accordance with various aspects of the present disclosure. The example channel may be representative of an individual channel included in a plurality of distinct wavelength channels of the multi-channel optical signal that may be demultiplexed and/or multiplexed by demultiplexer 206 of FIG. 2A and/or multiplexer 208 of FIG. 2B. Each of the distinct wavelength channels may have different center wavelengths (λ_{N}) including at least one of 1271 nm, 1291 nm, 1311 nm, 1331 nm, 1506 nm, 1514 nm, 1551 nm, or 1571 nm, or otherwise. In the illustrated embodiment of FIG. 2C, the distinct wavelength channel has a channel bandwidth 212 of approximately 13 nm wide. However, in other embodiments the channel bandwidth may be different than 13 nm wide. Rather, the channel bandwidth may be considered a configurable parameter that is dependent upon the structure of MUX/DEMUX 114 of FIG. 1, demultiplexer 206 of FIG. 2A, and/or multiplexer 208 of FIG. 2B. For example, in some embodiments each of the plurality of distinct wavelength channels may share a common bandwidth that may correspond to 13 nm or otherwise. Referring back to FIG. 2C, the channel bandwidth 212 may be defined as the width of a passband region 218 (i.e., the region defined as being between PB₁ and PB₂). The passband region 218 may represent an approximate power transmission of a demultiplexer or multiplexer. It is appreciated that in some embodiments the passband region 218 may include ripple as illustrated in FIG. 2C, which corresponds to fluctuations within the passband region 218. In one or more embodiments, the ripple within the passband region around a central value 214 may be +/−2 dB or less, +/−1 dB or less, +/−0.5 dB or less, or otherwise. In some embodiments, the channel bandwidth 212 may be defined by the passband region 218. In other embodiments, the channel bandwidth 212 may be defined as the measured power above a threshold (e.g., dBₜₕ). For example, demultiplexer 206 illustrated in FIG. 2A may optically separate channel N from multi-channel optical signal 110 and have a corresponding channel bandwidth for channel N equivalent to the range of wavelengths above a threshold value that are transmitted to the output region 204 mapped to channel N (i.e., λ_{N}). In the same or other embodiments, isolation of the channel (i.e., defined by channel bandwidth 212) may also be considered when optimizing the design. The isolation may be defined as a ratio between the passband region 218 and the stopband regions (e.g., regions less than SB₁ and greater than SB₂). It is further appreciated that transition band regions (e.g., a first transition region between SB₁ and PB₁ and a second transition region between PB₂ and SB₂) are exemplary and may be exaggerated for the purposes of illustration. In some embodiments, optimization of the design of the photonic demultiplexer may also include a target metric for a slope, width, or the like of the transition band regions.

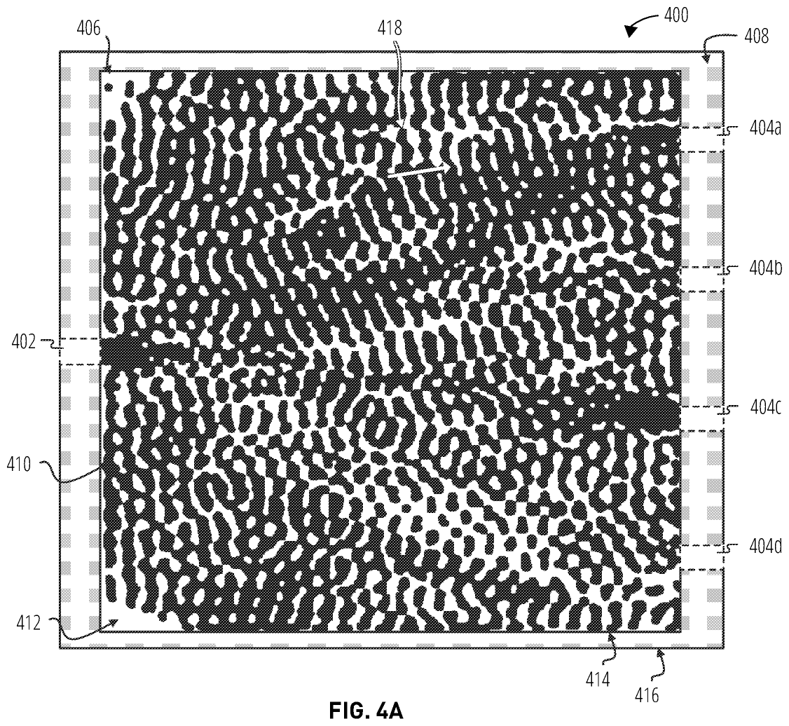

FIG. 3A-FIG. 3D illustrate different views of an example photonic demultiplexer, in accordance with an embodiment of the present disclosure. Photonic demultiplexer 316 is one possible implementation of MUX/DEMUX 114 illustrated in FIG. 1 and demultiplexer 206 illustrated in FIG. 2A. It is further appreciated that while discussion henceforth may be directed towards photonic integrated circuits capable of demultiplexing a plurality of distinct wavelength channels from a multi-channel optical signal, that in other embodiments, a demultiplexer (e.g., demultiplexer 316) may also or alternatively be capable of multiplexing a plurality of distinct wavelength channels into a multi-channel optical signal, in accordance with embodiments of the present disclosure.

FIG. 3A illustrates a cross-sectional view of demultiplexer 316 along a lateral plane within an active layer defined by a width 320 and a length 322 of the demultiplexer 316. As illustrated, demultiplexer 316 includes an input region 302 (e.g., comparable to input region 202 illustrated in FIG. 2A), a plurality of output regions 304 (e.g., comparable to plurality of output regions 204 illustrated in FIG. 2A), and a dispersive region optically disposed between the input region 302 and plurality of output regions 304. The input region 302 and plurality of output regions 304 (e.g., output region 308, output region 310, output region 312, and output region 314) may each be waveguides (e.g., slab waveguide, strip waveguide, slot waveguide, or the like) capable of propagating light along the path of the waveguide. The dispersive region 332 includes a first material and a second material (see, e.g., FIG. 3D) inhomogeneously interspersed to form a plurality of interfaces that each correspond to a change in refractive index of the dispersive region 332 and collectively structure the dispersive region 332 to optically separate each of a plurality of distinct wavelength channels (e.g., Ch. 1, Ch. 2, Ch. 3, . . . Ch. N illustrated in FIG. 2A) from a multi-channel optical signal (e.g., optical signal 110 illustrated in FIG. 2A) and respectively guide each of the plurality of distinct wavelength channels to a corresponding one of the plurality of output regions 304 when the input region 302 receives the multi-channel optical signal. In other words, input region 302 is adapted to receive the multi-channel optical signal including a plurality of distinct wavelength channels and the plurality of output regions 304 are adapted to each receive a corresponding one of the plurality of distinct wavelength channels demultiplexed from the multi-channel optical signal via dispersive region 332.

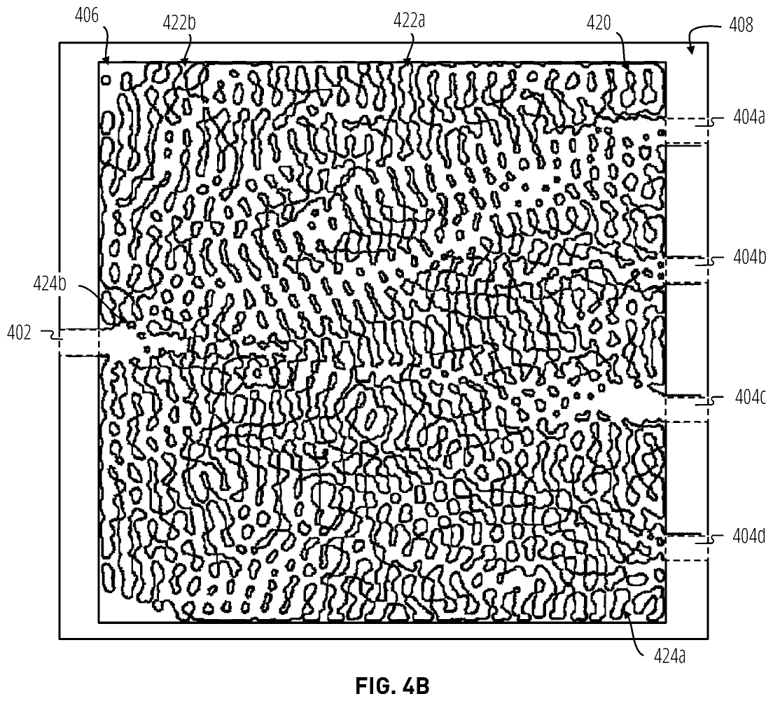

As illustrated in FIG. 3A, and more clearly shown in FIG. 3D and FIG. 4A-FIG. 4B, the shape and arrangement of the first and second material that are inhomogeneously interspersed create a plurality of interfaces that collectively form a material interface pattern along a cross-sectional area of dispersive region 332 that is at least partially surrounded by a periphery region 318 that includes the second material. In some embodiments periphery region 318 has a substantially homogeneous composition that includes the second material. In the illustrated embodiment, dispersive region 332 includes a first side 328 and a second side 330 that each interface with an inner boundary (i.e., the unlabeled dashed line of periphery region 318 disposed between dispersive region 332 and dashed-dotted line corresponding to an outer boundary of periphery region 318). First side 328 and second side 330 are disposed correspond to opposing sides of dispersive region 332. Input region 302 is disposed proximate to first side 328 (e.g., one side of input region 302 abuts first side 328 of dispersive region 332) while each of the plurality of output regions 304 are disposed proximate to second side 330 (e.g., one side of each of the plurality of output regions 304 abuts second side 330 of dispersive region 332).

In the illustrated embodiment each of the plurality of output regions 304 are parallel to each other one of the plurality of output regions 304. However, in other embodiments the plurality of output regions 304 may not be parallel to one another or even disposed on the same side (e.g., one or more of the plurality of output regions 304 and/or input region 302 may be disposed proximate to sides of dispersive region 332 that are adjacent to first side 328 and/or second side 330). In some embodiments adjacent ones of the plurality of output regions are separated from each other by a common separation distance when the plurality of output regions includes at least three output regions. For example, as illustrated adjacent output region 308 and output region 310 are separated from one another by distance 306, which may be common to the separation distance between other pairs of adjacent output regions.

As illustrated in the embodiment of FIG. 3A, demultiplexer 316 includes four output regions 304 (e.g., output region 308, output region 310, output region 312, output region 314) that are each respectively mapped (i.e., by virtue of the structure of dispersive region 332) to a respective one of four channels included in a plurality of distinct wavelength channels. More specifically, the plurality of interfaces of dispersive region 332, defined by the inhomogeneous interspersion of a first material and a second material, form a material interface pattern along a cross-sectional area of the dispersive region 332 (e.g., as illustrated in FIG. 3A, FIG. 4A, or FIG. 4B) to cause the dispersive region 332 to optically separate each of the four channels from the multi-channel optical signal and route each of the four channels to a respective one of the four output regions 304 when the input region 302 regions the multi-channel optical signal.

It is noted that the first material and second material of dispersive region 332 are arranged and shaped within the dispersive region such that the material interface pattern is substantially proportional to a design obtainable with an inverse design process, which will be discussed in greater detail later in the present disclosure. More specifically, in some embodiments, the inverse design process may include iterative gradient-based optimization of a design based at least in part on a loss function that incorporates a performance loss (e.g., to enforce functionality) and a fabrication loss (e.g., to enforce fabricability and binarization of a first material and a second material) that is reduced or otherwise adjusted via iterative gradient-based optimization to generate the design. In the same or other embodiment, other optimization techniques may be used instead of, or jointly with, gradient-based optimization. Advantageously, this allows for optimization of a near unlimited number of design parameters to achieve functionality and performance within a predetermined area that may not have been possible with conventional design techniques.

For example, in one embodiment dispersive region 332 is structured to optically separate each of the four channels from the multi-channel optical signal within a predetermined area of 35 μm×35 μm (e.g., as defined by width 324 and length 326 of dispersive region 332) when the input region 302 receives the multi-channel optical signal. In the same or another embodiment, the dispersive region is structured to accommodate a common bandwidth for each of the four channels, each of the four channels having different center wavelengths. In one embodiment the common bandwidth is approximately 13 nm wide and the different center wavelengths is selected from a group consisting of 1271 nm, 1291 nm, 1311 nm, 1331 nm, 1506 nm, 1514 nm, 1551 nm, and 1571 nm. In some embodiments, the entire structure of demultiplexer 316 (e.g., including input region 302, periphery region 318, dispersive region 332, and plurality of output regions 304) fits within a predetermined area (e.g., as defined by width 320 and length 322). In one embodiment the predetermined area is 35 μm×35 μm. It is appreciated that in other embodiments dispersive region 332 and/or demultiplexer 316 fits within other areas greater than or less than 35 μm×35 μm, which may result in changes to the structure of dispersive region 332 (e.g., the arrangement and shape of the first and second material) and/or other components of demultiplexer 316.

In the same or other embodiments the dispersive region is structured to have a power transmission of −2 dB or greater from the input region 302, through the dispersive region 332, and to the corresponding one of the plurality of output regions 304 for a given wavelength within one of the plurality of distinct wavelength channels. For example, if channel 1 of a multi-channel optical signal is mapped to output region 308, then when demultiplexer 316 receives the multi-channel optical signal at input region 302 the dispersive region 332 will optically separate channel 1 from the multi-channel optical signal and guide a portion of the multi-channel optical signal corresponding to channel 1 to output region 308 with a power transmission of −2 dB or greater. In the same or another embodiment, dispersive region 332 is structured such that an adverse power transmission (i.e., isolation) for the given wavelength from the input region to any of the plurality of output regions other than the corresponding one of the plurality of output regions is −30 dB or less, −22 dB or less, or otherwise. For example, if channel 1 of a multi-channel optical signal is mapped to output region 308, then the adverse power transmission from input region 302 to any other one of the plurality of output regions (e.g., output region 310, output region 312, output region 314) other than the corresponding one of the plurality of output regions (e.g., output region 308) is −30 dB or less, −22 dB or less, or otherwise. In some embodiments, a maximum power reflection from demultiplexer 316 of an input signal (e.g., a multi-channel optical signal) received at an input region (e.g., input region 302) is reflected back to the input region by dispersive region 332 or otherwise is −40 dB or less, −20 dB or less, −8 dB or less, or otherwise. It is appreciated that in other embodiments the power transmission, adverse power transmission, maximum power, or other performance characteristics may be different than the respective values discussed herein, but the structure of dispersive region 332 may change due to the intrinsic relationship between structure, functionality, and performance of demultiplexer 316.

FIG. 3B illustrates a vertical schematic or stack of various layers that are included in the illustrated embodiment of demultiplexer 316. However, it is appreciated that the illustrated embodiment is not exhaustive and that certain features or elements may be omitted to avoid obscuring certain aspects of the invention. In the illustrated embodiment, demultiplexer 316 includes substrate 334, dielectric layer 336, active layer 338 (e.g., as shown in the cross-sectional illustration of FIG. 3A), and a cladding layer 340. In some embodiments, demultiplexer 316 may be, in part or otherwise, a photonic integrated circuit or silicon photonic device that is compatible with conventional fabrication techniques (e.g., lithographic techniques such as photolithographic, electron-beam lithography and the like, sputtering, thermal evaporation, physical and chemical vapor deposition, and the like).

In one embodiment a silicon on insulator (SOI) wafer may be initially provided that includes a support substrate (e.g., a silicon substrate) that corresponds to substrate 334, a silicon dioxide dielectric layer that corresponds to dielectric layer 336, a silicon layer (e.g., intrinsic, doped, or otherwise), and a oxide layer (e.g., intrinsic, grown, or otherwise). In one embodiment, the silicon in the active layer 338 may be etched selectively by lithographically creating a pattern on the SOI wafer that is transferred to SOI wafer via a dry etch process (e.g., via a photoresist mask or other hard mask) to remove portions of the silicon. The silicon may be etched all the way down to dielectric layer 336 to form voids that may subsequently be backfilled with silicon dioxide that is subsequently encapsulated with silicon dioxide to form cladding layer 340. In one embodiment, there may be several etch depths including a full etch depth of the silicon to obtain the targeted structure. In one embodiment, the silicon may be 220 nm thick and thus the full etch depth may be 220 nm. In some embodiments, this may be a two-step encapsulation process in which two silicon dioxide depositions are performed with an intermediate chemical mechanical planarization used to yield a planar surface.

FIG. 3C illustrates a more detailed view of active layer 338 (relative to FIG. 3B) taken along a portion of periphery region 318 that includes input region 302 of FIG. 3A. In the illustrated embodiment, active layer 338 includes a first material 342 with a refractive index of 81 and a second material 344 with a refractive index of 22 that is different from 81. Homogenous regions of the first material 342 and the second material 344 may form waveguides or portions of waveguides that correspond to input region 302 and plurality of output regions 304 as illustrated in FIG. 3A and FIG. 3C.

FIG. 3D illustrates a more detailed view of active layer 338 (relative to FIG. 3B) taken along dispersive region 332. As described previously, active layer 338 includes a first material 342 (e.g., silicon) and a second material 344 (e.g., silicon dioxide) that are inhomogeneously interspersed to form a plurality of interfaces 346 that collectively form a material interface pattern. Each of the plurality of interfaces 346 that form the interface pattern correspond to a change in refractive index of dispersive region 332 to structure the dispersive region (i.e., the shape and arrangement of first material 342 and second material 344) to provide, at least in part, the functionality of demultiplexer 316 (i.e., optical separation of the plurality of distinct wavelength channels from the multi-channel optical signal and respective guidance of each of the plurality of distinct wavelength channels to the corresponding one of the plurality of output regions 304 when the input region 302 receives the multi-channel optical signal).

It is appreciated that in the illustrated embodiments of demultiplexer 316 as shown in FIG. 3A-FIG. 3D, the change in refractive index is shown as being vertically consistent (i.e., the first material 342 and second material 344 form interfaces that are substantially vertical or perpendicular to a lateral plane or cross-section of demultiplexer 316. However, in the same or other embodiments, the plurality of interfaces (e.g., interfaces 346 illustrated in FIG. 3D) may not be substantially perpendicular with the lateral plane or cross-section of demultiplexer 316.

FIG. 4A illustrates a more detailed cross-sectional view of a dispersive region of example photonic demultiplexer 400, in accordance with an embodiment of the present disclosure. FIG. 4B illustrates a more detailed view of an interface pattern formed by the shape and arrangement of a first material 410 and a second material 412 for the dispersive region of the photonic demultiplexer 400 of FIG. 4A. Photonic demultiplexer 400 is one possible implementation of MUX/DEMUX 114 illustrated in FIG. 1, demultiplexer 206 illustrated in FIG. 2A, and demultiplexer 316 illustrated in FIG. 3A-FIG. 3D.

As illustrated in FIG. 4A and FIG. 4B, photonic demultiplexer 400 includes an input region 402, a plurality of output regions 404a-404d, and a dispersive region 406 optically disposed between input region 402 and plurality of output regions 404a-404d. Dispersive region 406 is surrounded, at least in part, by a peripheral region 408 that includes an inner boundary 414 and an outer boundary 416. It is appreciated that like named or labeled elements of photonic demultiplexer 400 may similarly correspond to like named or labeled elements of other demultiplexers described in embodiments of the present disclosure.

The first material 410 (i.e., black colored regions within dispersive region 406) and second material 412 (i.e., white colored regions within dispersive region 406) of photonic demultiplexer 400 are inhomogeneously interspersed to create a plurality of interfaces that collectively form material interface pattern 420 as illustrated in FIG. 4B. More specifically, an inverse design process that utilizes iterative gradient-based optimization, Markov Chain Monte Carlo optimization, or other optimization techniques combined with first principles simulations to generate a design that is substantially replicated by dispersive region 406 within a proportional or scaled manner such that photonic demultiplexer 400 provides the desired functionality. In the illustrated embodiment, dispersive region 406 is structured to optically separate each of a plurality of distinct wavelength channels from a multi-channel optical signal and respectively guide each of the plurality of distinct wavelength channels to a corresponding one of the plurality of output regions 404a-404d when the input region 402 receives the multi-channel optical signal. More specifically, the plurality of output regions 404a-404d are respectively mapped to wavelength channels having center wavelengths correspond to 1271 nm, 1291 nm, 1311 nm, and 1331 nm. In another embodiment, output regions 404a-404d are respectfully mapped to wavelength channels having center wavelengths that correspond to 1506 nm, 1514 nm, 1551 nm, and 1571 nm.

As illustrated in FIG. 4B, material interface pattern 420, which is defined by the black lines within dispersive region 406 and corresponds to a change in refractive index within dispersive region 406, includes a plurality of protrusions 422a-422b. A first protrusion 422a is formed of the first material 410 and extends from peripheral region 408 into dispersive region 406. Similarly, a second protrusion 422b is formed of the second material 412 and extends from peripheral region 408 into dispersive region 406. Further illustrated in FIG. 4B, dispersive region 406 includes a plurality of islands 424a-424b formed of either the first material 410 or the second material 412. The plurality of islands 424a-424b include a first island 424a that is formed of the first material 410 and is surrounded by the second material 412. The plurality of islands 424a-424b also includes a second island 424b that is formed of the second material 412 and is surrounded by the first material 410.

In some embodiments, material interface pattern 420 includes one or more dendritic shapes, wherein each of the one or more dendritic shapes are defined as a branched structure formed from first material 410 or second material 412 and having a width that alternates between increasing and decreasing in size along a corresponding direction. Referring back to FIG. 4A, for clarity, dendritic structure 418 is labeled with a white arrow having a black border. As can be seen, the width of dendritic structure 418 alternatively increases and decreases in size along a corresponding direction (i.e., the white labeled arrow overlaying a length of dendritic structure 418) to create a branched structure. It is appreciated that in other embodiments there may be no protrusions, there may be no islands, there may be no dendritic structures, or there may be any number, including zero, of protrusions, islands of any material included in the dispersive region 406, dendritic structures, or a combination thereof.

In some embodiments, the inverse design process includes a fabrication loss that enforces a minimum feature size, for example, to ensure fabricability of the design. In the illustrated embodiment of photonic demultiplexer 400 illustrated in FIG. 4A and FIG. 4B, material interface pattern 420 is shaped to enforce a minimum feature size within dispersive region 406 such that the plurality of interfaces within the cross-sectional area formed with first material 410 and second material 412 do not have a radius of curvature with a magnitude of less than a threshold size. For example, if the minimum feature size is 150 nm, the radius of curvature for any of the plurality of interfaces have a magnitude of less than the threshold size, which corresponds the inverse of half the minimum feature size (i.e., 1/75 nm⁻¹). Enforcement of such a minimum feature size prevents the inverse design process from generating designs that are not fabricable by considering manufacturing constraints, limitations, and/or yield. In the same or other embodiments, different or additional checks on metrics related to fabricability may be utilized to enforce a minimum width or spacing as a minimum feature size.

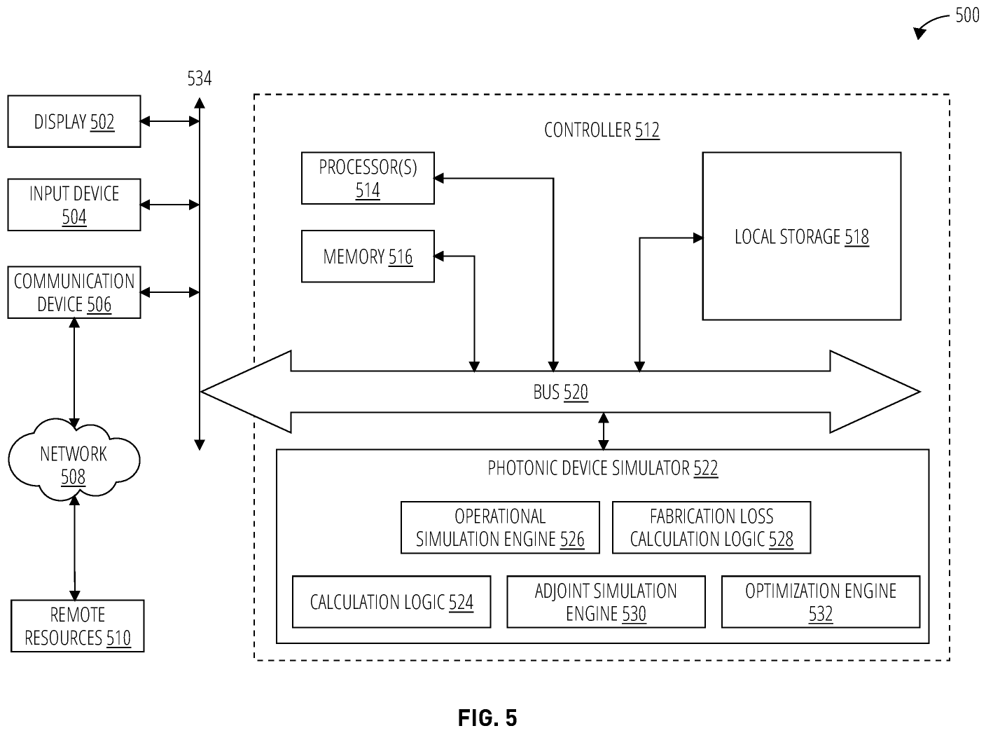

FIG. 5 is a functional block diagram illustrating a computing system 500 for generating a design of an optoelectronic device (i.e., photonic device), in accordance with an embodiment of the disclosure. Computing system 500 may be utilized to perform an inverse design process that generates a design with iterative gradient-based optimization that takes into consideration the underlying physics that govern the operation of the photonic integrated circuit. More specifically, computing system 500 is a design tool that may be utilized to optimize structural parameters (e.g., shape and arrangement of a first material and a second material within the dispersive region of the embodiments described in the present disclosure) of photonic integrated circuits based on first-principles simulations (e.g., electromagnetic simulations to determine a field response of the photonic device to an excitation source) and iterative gradient-based optimization. In other words, computing system 500 may provide a design obtained via the inverse design process that is substantially replicated (i.e., proportionally scaled) by dispersive region 332 and dispersive region 406 of demultiplexer 316 and photonic demultiplexer 400 illustrated in FIG. 3A and FIG. 4A, respectively.

As illustrated, computing system 500 includes controller 512, display 502, input device(s) 504, communication device(s) 506, network 508, remote resources 510, bus 534, and bus 520. Controller 512 includes processor 514, memory 516, local storage 518, and photonic device simulator 522. Photonic device simulator 522 includes operational simulation engine 526, fabrication loss calculation logic 528, calculation logic 524, adjoint simulation engine 530, and optimization engine 532. It is appreciated that in some embodiments, controller 512 may be a distributed system.

Controller 512 is coupled to display 502 (e.g., a light emitting diode display, a liquid crystal display, and the like) coupled to bus 534 through bus 520 for displaying information to a user utilizing computing system 500 to optimize structural parameters of the photonic device (i.e., demultiplexer). Input device 504 is coupled to bus 534 through bus 520 for communicating information and command selections to processor 514. Input device 504 may include a mouse, trackball, keyboard, stylus, or other computer peripheral, to facilitate an interaction between the user and controller 512. In response, controller 512 may provide verification of the interaction through display 502.

Another device, which may optionally be coupled to controller 512, is a communication device 506 for accessing remote resources 510 of a distributed system via network 508. Communication device 506 may include any of a number of networking peripheral devices such as those used for coupling to an Ethernet, Internet, or wide area network, and the like. Communication device 506 may further include a mechanism that provides connectivity between controller 512 and the outside world. Note that any or all of the components of computing system 500 illustrated in FIG. 5 and associated hardware may be used in various embodiments of the present disclosure. The remote resources 510 may be part of a distributed system and include any number of processors, memory, and other resources for optimizing the structural parameters of the photonic device.

Controller 512 orchestrates operation of computing system 500 for optimizing structural parameters of the photonic device. Processor 514 (e.g., one or more central processing units, graphics processing units, and/or tensor processing units, etc.), memory 516 (e.g., volatile memory such as DRAM and SRAM, non-volatile memory such as ROM, flash memory, and the like), local storage 518 (e.g., magnetic memory such as computer disk drives), and the photonic device simulator 522 are coupled to each other through bus 520. Controller 512 includes software (e.g., instructions included in memory 516 coupled to processor 514) and/or hardware logic (e.g., application specific integrated circuits, field-programmable gate arrays, and the like) that when executed by controller 512 causes controller 512 or computing system 500 to perform operations. The operations may be based on instructions stored within any one of, or a combination of, memory 516, local storage 518, physical device simulator 522, and remote resources 510 accessed through network 508.

In the illustrated embodiment, the components of photonic device simulator 522 are utilized to optimize structural parameters of the photonic device (e.g., MUX/DEMUX 114 of FIG. 1, demultiplexer 206 of FIG. 2A, multiplexer 208 of FIG. 2B, demultiplexer 316 of FIG. 3A-FIG. 3D, and photonic demultiplexer 400 of FIG. 4A-FIG. 4B). In some embodiments, computing system 500 may optimize the structural parameters of the photonic device via, inter alia, simulations (e.g., operational and adjoint simulations) that utilize a finite-difference time-domain (FDTD) method, a finite-difference frequency-domain (FDFD) method, or any other suitable technique to model the field response (e.g., electric and magnetic fields within the photonic device). The operational simulation engine 526 provides instructions for performing an electromagnetic simulation of the photonic device operating in response to an excitation source within a simulated environment. In particular, the operational simulation determines a field response of the simulated environment (and thus the photonic device, which is described by the simulated environment) in response to the excitation source for determining a performance metric of the physical device (e.g., based off an initial description or input design of the photonic device that describes the structural parameters of the photonic device within the simulated environment with a plurality of voxel). The structural parameters may correspond, for example, to the specific design, material compositions, dimensions, and the like of the physical device. Fabrication loss calculation logic 528 provides instructions for determining a fabrication loss, which is utilized to enforce a minimum feature size to ensure fabricability. In some embodiments, the fabrication loss is also used to enforce binarization of the design (i.e., such that the photonic device includes a first material and a second material that are interspersed to form a plurality of interfaces). Calculation logic 524 computes a loss metric determined via a loss function that incorporates a performance loss, based on the performance metric, and the fabrication loss. Adjoint simulation engine 530 is utilized in conjunction with the operational simulation engine 526 to perform an adjoint simulation of the photonic device to backpropagate the loss metric through the simulated environment via the loss function to determine how changes in the structural parameters of the photonic device influence the loss metric. Optimization engine 532 is utilized to update the structural parameters of the photonic device to reduce the loss metric and generate a revised description (i.e., revising the design) of the photonic device.

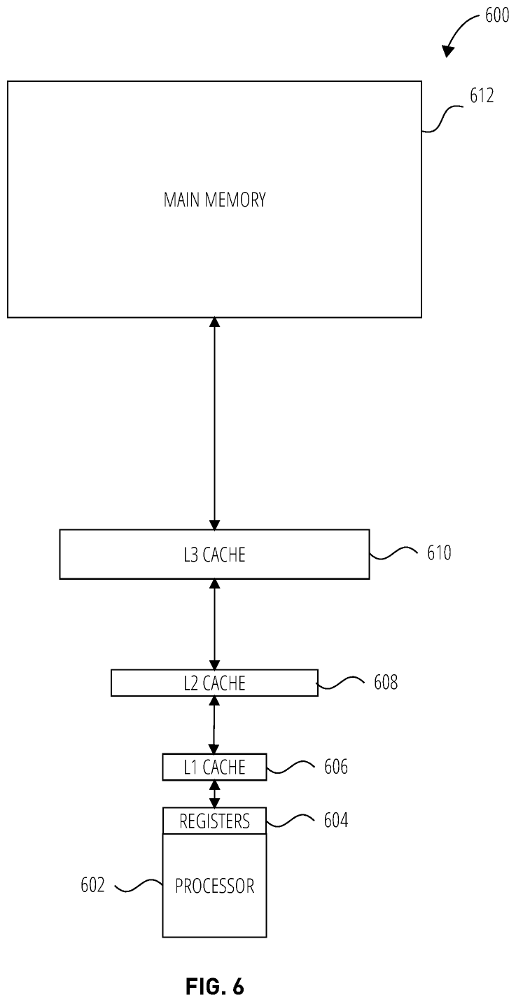

FIG. 6 is a schematic drawing of a memory and processing architecture used by a computing system such as controller 512 according to various aspects of the present disclosure. In the architecture 600, a processor 602 (such as processor(s) 514 illustrated in FIG. 5) executes instructions in order to perform computations, retrieve or store values from memory, and/or perform any other action typically performed by a computing processor.

The instructions executed by the processor 602 typically operate on values stored in registers 604, which are typically embodied by circuitry of the processor 602 that is configured to store values retrieved from memory. In order to perform an operation using a value from memory, the processor 602 first copies (or “loads”) the value from memory into a register 604. After generating a new value, the processor 602 copies (or “stores”) the value from a register 604 into memory. Access to a register 604 by the processor 602 is very fast, typically taking only a single clock cycle.

In the architecture 600, various different levels of memory are provided, with tradeoffs between storage volume and speed of access being made at each level. Typically, a first level of memory is an L1 cache 606. This is the fastest level of memory within the architecture 600, such that the processor 602 can load and store values from the L1 cache 606 faster than any other level of memory. For example, in some embodiments, it may take 5 clock cycles to read or store values in the L1 cache 606, though in other embodiments, it may take a different number of clock cycles, and the number of clock cycles may be different depending on the type of value (e.g., floating point values may take longer). Typically, the L1 cache 606 is also the smallest level of memory due to physical constraints and cost. Multiple L1 caches 606 may be provided, such as a separate instruction cache and data cache.

Additional levels of cache memory, such as an L2 cache 608, an L3 cache 610, or even further levels of cache memory (not illustrated) may be present, with the speed of access going down but the amount of available storage going up in each successive higher level of cache. For example, the L2 cache 608 may take twice as long to be accessed compared to the L1 cache 606. In some embodiments, higher levels of cache may be shared by multiple processors 602. For example, an L3 cache 610 may be shared by multiple processing cores in a single processor 602.

The slowest and largest memory is the main memory 612. Main memory 612 is typically dynamic random access memory (DRAM) implemented using capacitors and takes roughly 100 nanoseconds to access a value, whereas the cache memories are typically implemented using static random access memory (SRAM) implemented using transistors and can be roughly 10 times faster than DRAM. The tradeoff is that main memory 612 has a much larger capacity than the cache memories, and so can hold large amounts of data (such as the entirety of the data for conducting operational simulations as described below).

When a processor 602 loads a value into a register 604, it first checks the L1 cache 606 to see if the value can be loaded quickly from there (a “cache hit”). If the value is present, then the value is loaded from the L1 cache 606. Otherwise, if the value is not present in the L1 cache 606 (a “cache miss”), the processor 602 next checks the L2 cache 608 to see if the value can be loaded quickly from there. This proceeds through each level of cache memory until, if none of the cache memories store the value, the value will be retrieved from main memory 612. Once the value is found, it is stored in each of the cache memories until it is removed to make space for a new value. The use of cache memory speeds up computations, particularly for values that are repeatedly read, since values that have been accessed recently are more likely to already be stored in a cache memory when they are needed.

Though only a single processor 602 and three levels of cache memory are illustrated, one of skill in the art will recognize that in some embodiments, multiple processors 602, more or fewer levels of cache memory than the illustrated three levels, and more copies of a given level of cache memory may be present in an embodiment of a controller 512. One of skill in the art will also understand that various strategies may be used to load values into a lower level cache memory from a higher level cache memory, and to choose values to be overwritten in a lower level cache memory once the lower level cache memory is full. Since such strategies are known to those of ordinary skill in the art, they are not described further herein for the sake of brevity.

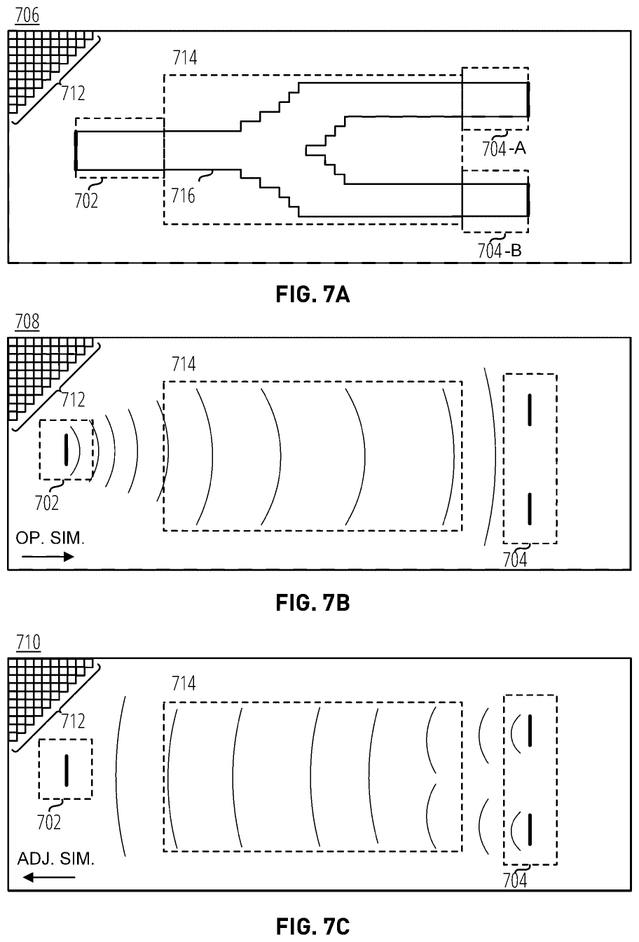

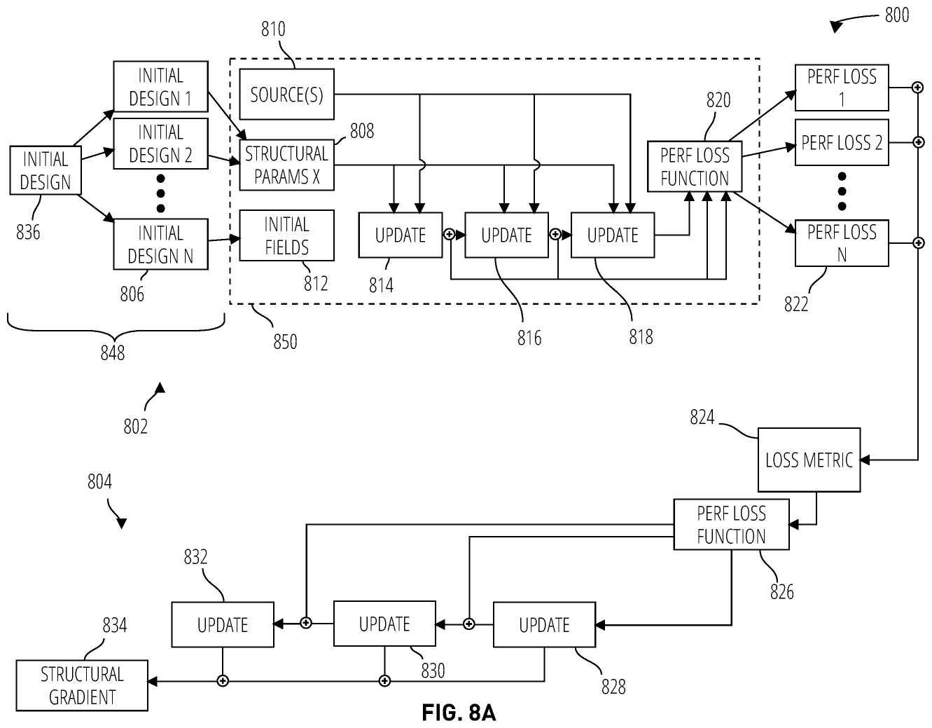

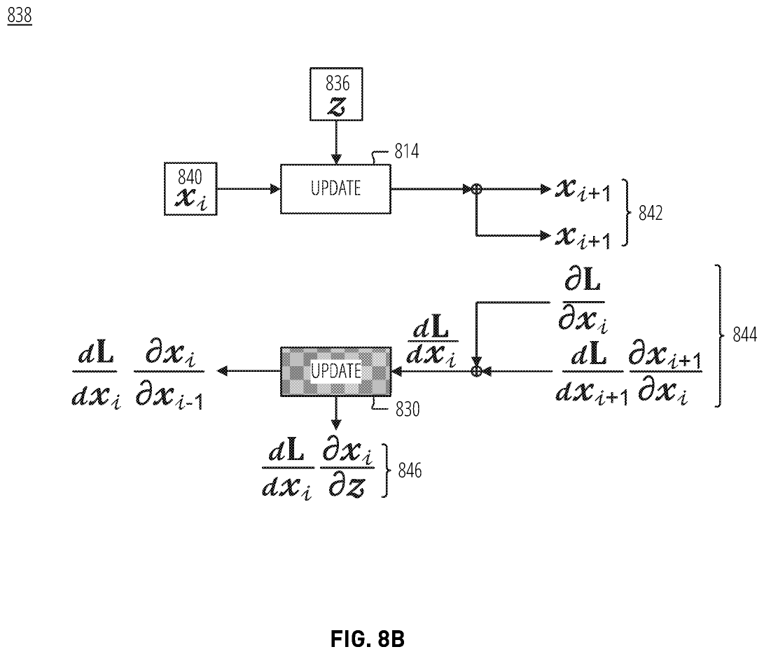

FIG. 7A-FIG. 7C respectively illustrate non-limiting example embodiments of an initial set up of a simulated environment 706 describing a photonic device, performing an operational simulation of the photonic device in response to an excitation source within the simulated environment 708, and performing an adjoint simulation of the photonic device within the simulated environment 710 according to various aspects of the present disclosure. The initial set up of the simulated environment, 1-dimensional representation of the simulated environment, operational simulation of the physical device, and adjoint simulation of the physical device may be implemented with computing system 500 illustrated in FIG. 5.

As illustrated in FIG. 7A-FIG. 7C, simulated environment is represented in two-dimensions. However, it is appreciated that other dimensionality (e.g., 3-dimensional space) may also be used to describe simulated environment and the photonic device. In some embodiments, optimization of structural parameters of the photonic device illustrated in FIG. 7A-FIG. 7C may be achieved via an inverse design process including, inter alia, simulations (e.g., operational simulations and adjoint simulations) that utilize a finite-difference time-domain (FDTD) method, a finite-difference frequency-domain (FDFD) method, or any other suitable technique to model the field response (e.g., electric and magnetic field) to an excitation source.

FIG. 7A illustrates a demonstrative simulated environment 706 describing a photonic integrated circuit (i.e., a photonic device such as a waveguide, demultiplexer, and the like), in accordance with a non-limiting example embodiment of the present disclosure. More specifically, in response to receiving an initial description of a photonic device defined by one or more structural parameters (e.g., an input design), a system (e.g., computing system 500 of FIG. 5) configures a simulated environment 706 to be representative of the photonic device. As illustrated, the simulated environment 706 (and subsequently the photonic device) is described by a plurality of voxels 712, which represent individual elements (i.e., discretized) of the two-dimensional (or other dimensionality) space. Each of the voxels 712 is illustrated as a two-dimensional square; however, it is appreciated that the voxels may be represented as cubes or other shapes in three-dimensional space. It is appreciated that the specific shape and dimensionality of the plurality of voxels 712 may be adjusted dependent on the simulated environment 706 and photonic device being simulated. It is further noted that a limited portion of the plurality of voxels 712 are illustrated to avoid obscuring other aspects of the simulated environment 706.

Each of the plurality of voxels 712 may be associated with a structural value, a field value, and a source value. Collectively, the structural values of the simulated environment 706 describe the structural parameters of the photonic device. In one embodiment, the structural values may correspond to a relative permittivity, permeability, and/or refractive index that collectively describe structural (i.e., material) boundaries or interfaces of the photonic device (e.g., material interface pattern 420 of FIG. 4B). For example, an interface 716 is representative of where relative permittivity changes within the simulated environment 706 and may define a boundary of the photonic device where a first material meets or otherwise interfaces with a second material. The field value describes the field (or loss) response that is calculated (e.g., via Maxwell's equations) in response to an excitation source described by the source value. The field response, for example, may correspond to a vector describing the electric and/or magnetic fields (e.g., in one or more orthogonal directions) at a particular time step for each of the plurality of voxel 712. Thus, the field response may be based, at least in part, on the structural parameters of the photonic device and the excitation source. In some embodiments, a separate field value may be determined and stored for each orthogonal direction being simulated (e.g., values on an X-axis, a Y-axis, and a Z-axis).

In the illustrated embodiment, the photonic device corresponds to an optical demultiplexer having a design region 714 (e.g., corresponding to dispersive region 332 of FIG. 3A, and/or dispersive region 406 of FIG. 4A), in which structural parameters of the physical device may be updated or otherwise revised. More specifically, through an inverse design process, iterative gradient-based optimization of a loss metric determined from a loss function is performed to generate a design of the photonic device that functionally causes a multi-channel optical signal to be demultiplexed and guided from input port 702 to a corresponding one of the output ports 704. Thus, input port 702 (e.g., corresponding to input region 302 of FIG. 3A, input region 402 of FIG. 4A, and the like) of the photonic device corresponds to a location of an excitation source to provide an output (e.g., a Gaussian pulse, a wave, a waveguide mode response, and the like). The output of the excitation source interacts with the photonic device based on the structural parameters (e.g., an electromagnetic wave corresponding to the excitation source may be perturbed, retransmitted, attenuated, refracted, reflected, diffracted, scattered, absorbed, dispersed, amplified, or otherwise as the wave propagates through the photonic device within simulated environment 706). In other words, the excitation source may cause the field response of the photonic device to change, which is dependent on the underlying physics governing the physical domain and the structural parameters of the photonic device. The excitation source originates or is otherwise proximate to input port 702 and is positioned to propagate (or otherwise influence the field values of the plurality of voxel) through the design region 714 towards output ports 704 of the photonic device. In the illustrated embodiment, the input port 702 and output ports 704 are positioned outside of the design region 714. In other words, in the illustrated embodiment, a portion of the structural parameters of the photonic device within a design region 714 are optimizable, while portions of the structural parameters of the photonic device outside the design region 714 are not optimizable.

However, in other embodiments, the entirety of the photonic device may be placed within the design region 714 such that the structural parameters may represent any portion or the entirety of the design of the photonic device. The electric and magnetic fields within the simulated environment 706 (and subsequently the photonic device) may change (e.g., represented by field values of the individual voxels that collectively correspond to the field response of the simulated environment) in response to the excitation source. The output ports 704 of the optical demultiplexer may be used for determining a performance metric of the photonic device in response to the excitation source (e.g., power transmission from input port 702 to a specific one of the output ports 704). The initial description of the photonic device, including initial structural parameters, excitation source, performance parameters or metrics, and other parameters describing the photonic device, are received by the system (e.g., computing system 500 of FIG. 5) and used to configure the simulated environment 706 for performing a first-principles based simulation of the photonic device. These specific values and parameters may be defined directly by a user (e.g., of computing system 500 in FIG. 5), indirectly (e.g., via controller 512 culling pre-determined values stored in memory 516, local storage 518, or remote resources 510), or a combination thereof.

FIG. 7B illustrates a non-limiting example embodiment of an operational simulation of the photonic device in response to an excitation source within simulated environment 708, in accordance with various aspects of the present disclosure. In the illustrated embodiment, the photonic device is an optical demultiplexer structured to optically separate each of a plurality of distinct wavelength channels included in a multi-channel optical signal received at input port 702 and respectively guide each of the plurality of distinct wavelength channels to a corresponding one of the plurality of output ports 704. The excitation source may be selected (randomly or otherwise) from the plurality of distinct wavelength channels and originates at input port 702 having a specified spatial, phase, and/or temporal profile. The operational simulation occurs over a plurality of time steps, including the illustrated time step. When performing the operational simulation, changes to the field response (e.g., the field value) for each of the plurality of voxels 712 are incrementally updated in response to the excitation source over the plurality of time steps. The changes in the field response at a particular time step are based, at least in part, on the structural parameters, the excitation source, and the field response of the simulated environment 710 at the immediately prior time step included in the plurality of time steps. Similarly, in some embodiments the source value of the plurality of voxels 712 is updated (e.g., based on the spatial profile and/or temporal profile describing the excitation source). It is appreciated that the operational simulation is incremental and that the field values (and source values) of the simulated environment 710 are updated incrementally at each time step as time moves forward for each of the plurality of time steps during the operational simulation. It is further noted that in some embodiments, the update is an iterative process and that the update of each field and source value is based, at least in part, on the previous update of each field and source value.

Once the operational simulation reaches a steady state (e.g., changes to the field values in response to the excitation source substantially stabilize or reduce to negligible values) or otherwise concludes, one or more performance metrics may be determined. In one embodiment, the performance metric corresponds to the power transmission at a corresponding one of the output ports 704 mapped to the distinct wavelength channel being simulated by the excitation source. In other words, in some embodiments, the performance metric represents power (at one or more frequencies of interest) in the target mode shape at the specific locations of the output ports 704. A loss value or metric of the input design (e.g., the initial design and/or any refined design in which the structural parameters have been updated) based, at least in part, on the performance metric may be determined via a loss function. The loss metric, in conjunction with an adjoint simulation, may be utilized to determine a structural gradient (e.g., influence of structural parameters on loss metric) for updating or otherwise revising the structural parameters to reduce the loss metric (i.e. increase the performance metric). It is noted that the loss metric may be further based on a fabrication loss value that is utilized to enforce a minimum feature size of the photonic device to promote fabricability of the device, and/or other loss values.

FIG. 7C illustrates a non-limiting example embodiment of an adjoint simulation within simulated environment 710 by backpropagating a loss metric, in accordance with various aspects of the present disclosure. More specifically, the adjoint simulation is a time-backwards simulation in which a loss metric is treated as an excitation source that interacts with the photonic device and causes a loss response. In other words, an adjoint (or virtual source) based on the loss metric is placed at the output region (e.g., output ports 704) or other location that corresponds to a location used when determining the performance metric. The adjoint source(s) is then treated as a physical stimuli or an excitation source during the adjoint simulation. A loss response of the simulated environment 708 is computed for each of the plurality of time steps (e.g., backwards in time) in response to the adjoint source. The loss response collectively refers to loss values of the plurality of voxels 712 that are incrementally updated in response to the adjoint source over the plurality of time steps. The change in loss response based on the loss metric may correspond to a loss gradient, which is indicative of how changes in the field response of the physical device influence the loss metric. The loss gradient and the field gradient may be combined in the appropriate way to determine a structural gradient of the photonic device/simulated environment (e.g., how changes in the structural parameters of the photonic device within the simulated environment influence the loss metric). Once the structural gradient of a particular cycle (e.g., operational and adjoint simulation) is known, the structural parameters may be updated to reduce the loss metric and generate a revised description or design of the photonic device.

In some embodiments, iterative cycles of performing the operational simulation, and adjoint simulation, determining the structural gradient, and updating the structural parameters to reduce the loss metric are performed successively as part of an inverse design process that utilizes iterative gradient-based optimization. An optimization scheme such as gradient descent may be utilized to determine specific amounts or degrees of changes to the structural parameters of the photonic device to incrementally reduce the loss metric. More specifically, after each cycle the structural parameters are updated (e.g., optimized) to reduce the loss metric. The operational simulation, adjoint simulation, and updating the structural parameters are iteratively repeated until the loss metric substantially converges or is otherwise below or within a threshold value or range such that the photonic device provides the desired performed while maintaining fabricability.

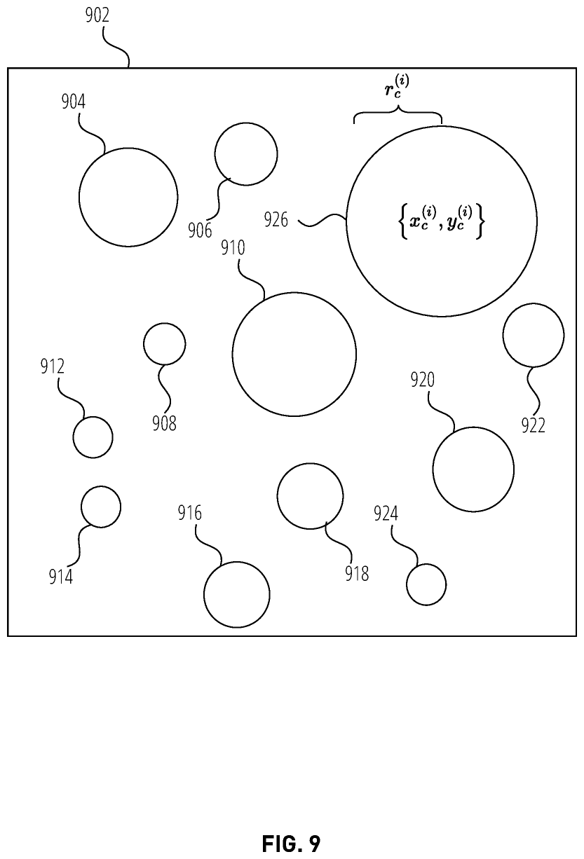

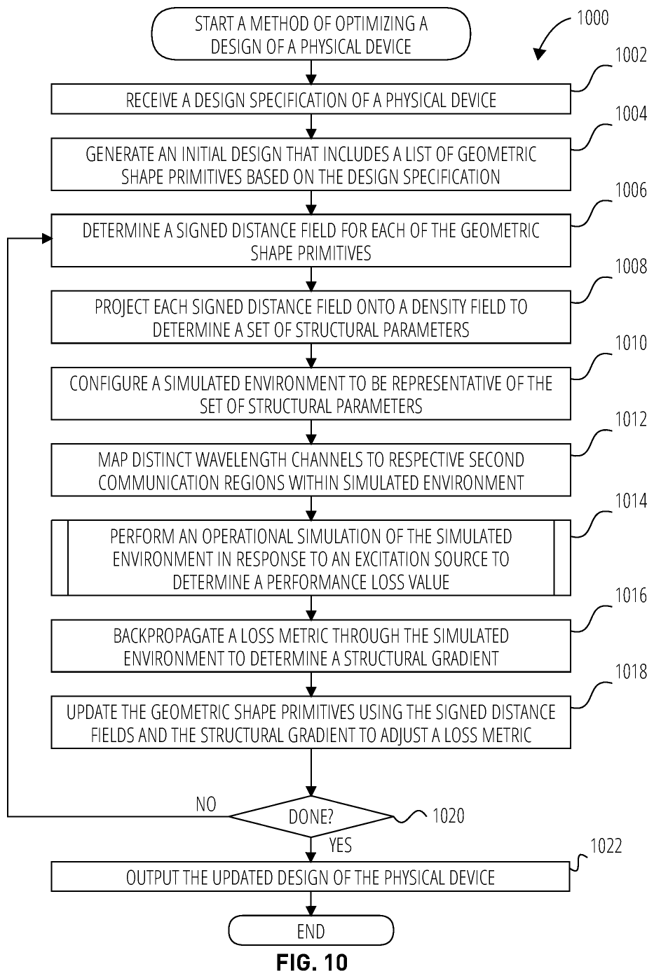

FIG. 8A is a flow chart 800 illustrating example time steps for an operational simulation 802 and an adjoint simulation 804, in accordance with various aspects of the present disclosure. Flow chart 800 is one possible implementation that a system may use to perform the operational simulation 802 and adjoint simulation 804 of the simulated environment describing a photonic integrated circuit (e.g., an optical device operating in an electromagnetic domain such a photonic demultiplexer). In the illustrated embodiment, the operational simulation 802 utilizes a finite-difference time-domain (FDTD) method, a finite-difference frequency-domain (FDFD) method, or any other suitable technique to model the field response (both electric and magnetic) or loss response at each of a plurality of voxels for a plurality of time steps in response to physical stimuli corresponding to an excitation source and/or adjoint source.

As illustrated in FIG. 8A, the operational simulation 802 includes a configuration portion 848 and a simulation portion 850. In the configuration portion 848, an initial design 836 is generated that is based on a design specification. In some embodiments, the design specification sets out one or more goals of the inverse design process, such as by providing expected performance characteristics and/or initial locations for one or more input ports, expected performance characteristics and/or initial locations for one or more output ports, a size of a design region, allowable locations for input ports and/or output ports, fabrication constraints (including but not limited to one or more of a minimum feature size, a minimum distance between features, or a boundary buffer).

In some embodiments, the initial design 836 includes a parameterization of the design. The parameters representing the design are optimized by the remainder of the operational simulation 802 and the adjoint simulation 804 in order to generate a design for the physical device that is highly performant. One non-limiting example parameterization is the voxel-based parameterization illustrated in FIG. 7A-FIG. 7C and described above. Other techniques for parameterization of the design are described below.

It is appreciated that the initial design 836 may be a relative term. Thus, in some embodiments an initial design 836 may be a first description of the physical device described within the context of the simulated environment (e.g., a first input design for performing a first operational simulation). However, in other embodiments, the term initial design 836 may refer to an initial design 836 of a particular cycle (e.g., of performing an operational simulation 802, operating an adjoint simulation 804, and updating the structural parameters). In such an embodiment, the initial design 836 or design of that particular cycle may correspond to a revised description or refined design (e.g., generated from a previous cycle). In some embodiments, the simulated environment includes a design region that includes a portion of the plurality of voxels which have structural parameters that may be updated, revised, or otherwise changed to optimize the structural parameters of the physical device. In the same or other embodiments, the structural parameters are associated with geometric boundaries and/or material compositions of the physical device based on the material properties (e.g., relative permittivity, index of refraction, etc.) of the simulated environment.

In some embodiments, after determining the initial design 836, the operational simulation 802 generates a plurality of perturbed initial designs 806. Each perturbed initial design 806 represents changes that would be present in the parameters of the initial design 836 after fabrication by the fabrication system under a different set of operating conditions. In some embodiments, a fabrication model may be used to simulate the fabrication of the photonic device based on the initial design 836 and the operating conditions in order to generate each perturbed initial design 806. For example, if an ambient temperature for a set of operating conditions is higher than a nominal or default ambient temperature, a corresponding perturbed initial design 806 may include features that have corners that are rounder or otherwise less precise than those that would be fabricated under the nominal or default ambient temperature.

In some embodiments, ranges of values for each of the operating conditions may be predetermined. Any suitable technique may then be used to determine the sets of operating conditions for generating the perturbed initial designs 806. For example, values within the predetermined ranges of values may be stochastically sampled for each of the operating conditions, and combinations of the stochastically sampled values may be used as the sets of operating conditions. As another example, values within the predetermined ranges of values may be uniformly sampled for each operating condition, and combinations of the uniformly sampled values may be used as the sets of operating conditions. As yet another example, a sensitivity for each operating condition may be determined, and then values within the predetermined ranges of values may be sampled in a non-linear manner based on the determined sensitivities. The sensitivities may be determined by analyzing the results obtained with a plurality of sets of operating conditions that vary each operating condition separately.

Although the flow chart 800 is illustrated with this step of generating a plurality of perturbed initial designs 806, in some embodiments, the single initial design 836 based directly on the design specification may be used without generating perturbed initial designs 806.

After the perturbed initial designs 806 are determined (or the single initial design 836 is generated), the operational simulation 802 proceeds to a simulation portion 850, which is performed separately for each perturbed initial design 806 (or once for the single initial design 836). To simulate the performance of the physical device, a set of structural parameters 808 are generated based on the perturbed initial design 806 (or the single initial design 836). The structural parameters 808 represent the physical structure of the physical device to be simulated, and may be represented by voxels 712 (or another format suitable for processing by the simulated environment) regardless of the specific parameterization provided by the initial design 836 or the perturbed initial design 806.

The simulation portion 850 occurs over a plurality of time-steps (e.g., from an initial time step to a final time step over a pre-determined or conditional number of time steps having a specified time step size) and models changes (e.g., from the initial field values 812) in electric and magnetic fields of a plurality of voxels describing the simulated environment and/or photonic device that collectively correspond to the field response. More specifically, update operations (e.g., update operation 814, update operation 816, and update operation 818) are iterative and based on the field response, structural parameters 808 (that is, for a selected one of the initial design 806), and one or more excitation sources 810. Each update operation is succeeded by another update operation, which are representative of successive steps forward in time within the plurality of time steps. For example, update operation 816 updates the field values 840 (see, e.g., FIG. 8B) based on the field response determined from the previous update operation 814, excitation sources 810, and the structural parameters 808. Similarly, update operation 818 updates the field values 842 (see, e.g., FIG. 8B) based on the field response determined from update operation 816. In other words, at each time step of the operational simulation the field values (and thus field response) are updated based on the previous field response and structural parameters of the photonic device.

Once the final time step of the simulation portion 850 is performed, a performance loss function 820 is used to determine a performance loss value 822 associated with the selected initial design 806. The performance loss values 822 for each of the perturbed initial designs 806 may be combined into a total performance loss value that can be used to determine (or used as) a loss metric 824. The performance loss values 822 may be combined using any suitable technique. For example, in some embodiments, a linear combination of the performance loss values 822 may be used as the total performance loss value. As another example, in embodiments wherein a non-linear sampling of the operating conditions was performed based on sensitivities associated with each operating condition, a non-linear combination of the performance loss values 822 based on the sensitivities may be performed to create the total performance loss value. In some embodiments, additional loss values, including but not limited to a fabrication loss value that is based on whether portions of the structural parameters 808 (and/or the perturbed initial designs 806 or initial design 836) are detected as violating one or more fabricability constraints, may be combined with the one or more performance loss values 822.

From the loss metric 824, loss gradients may be determined at block 826. The loss gradients determined from block 826 may be treated as adjoint or virtual sources (e.g., physical stimuli or excitation source originating at an output region or port) which are backpropagated in reverse (from the final time step incrementally through the plurality of time steps until reaching the initial time step via update operation 828, update operation 832, and update operation 830) to determine structural gradient 834. Because it is determined based on the total performance loss value, the structural gradient 834 is associated with the initial design 836, as opposed to an individual perturbed initial design 806. This allows the initial design 836 to be updated instead of having to individually process each of the perturbed initial designs 806 and propagate changes in the design back to the initial design 836, thus eliminating a large amount of unnecessary computation.

In the illustrated embodiment, the FDTD solve (e.g., simulation portion 850 of the operational simulation 802) and backward solve (e.g., adjoint simulation 804) problem are described pictorially, from a high-level, using only “update” and “loss” operations as well as their corresponding gradient operations. The simulation is set up initially in which the structural parameters, physical stimuli (i.e., excitation source), and initial field states of the simulated environment (and photonic device) are provided (e.g., via an initial description and/or input design). As discussed previously, the field values are updated in response to the excitation source based on the structural parameters. More specifically, the update operation is given by ϕ,

where [symbol] =ϕ(xᵢ, [symbol] , z) for [symbol] =1, . . . , [symbol] . Here, [symbol] corresponds to the total number of time steps (e.g., the plurality of time steps) for the operational simulation, where [symbol] corresponds to the field response (the field value associated with the electric and magnetic fields of each of the plurality of voxel) of the simulated environment at time step [symbol] , [symbol] corresponds to the excitation source(s) (the source value associated with the electric and magnetic fields for each of the plurality of voxel) of the simulated environment at time step [symbol] , and z corresponds to the structural parameters describing the topology and/or material properties of the physical device (e.g., relative permittivity, index of refraction, and the like).

It is noted that using the FDTD method, the update operation may specifically be stated as:

$$ϕ ( {x}_{i} , , z ) = A ( z ) {x}_{i} + B ( z )$$

That is to say the FDTD update is linear with respect to the field and source terms. Concretely, A(z)∈ [symbol] ^{N×N} and B(z)∈ [symbol] ^{N×N} are linear operators which depend on the structure parameters, z, and act on the fields, [symbol] , and the sources, [symbol] , respectively. Here, it is assumed that [symbol] , [symbol] ∈ [symbol] ^{N} where N is the number of FDTD field components in the operational simulation. Additionally, the loss operation (e.g., loss function) may be given by L=ƒ( [symbol] , . . . , xₙ), which takes as input the computed fields and produces a single, real-valued scalar (e.g., the loss metric) that can be reduced and/or minimized.

In terms of revising or otherwise optimizing the structural parameters of the physical device, the relevant quantity to produce is

$$\frac{d L}{d z} ,$$

which is used to describe the influence of changes in the structural parameters of the initial design 836 on the loss value and is denoted as the structural gradient 834 illustrated in FIG. 8A.

FIG. 8B is a chart 838 illustrating the relationship between the update operation for the operational simulation and the adjoint simulation (e.g., backpropagation), in accordance with an embodiment of the present disclosure. More specifically, FIG. 8B summarizes the operational and adjoint simulation relationships that are involved in computing the structural gradient,

$$\frac{dL}{dz} ,$$

which include

$$\frac{\partial L}{\partial {x}_{i}} , \frac{\partial {x}_{i + 1}}{\partial {x}_{i}} , \frac{dL}{{dx}_{i}} , and \frac{\partial {x}_{i}}{\partial z} .$$

The update operation 816 of the operational simulation 802 updates the field values 840, [symbol] , of the plurality of voxel at the ith time step to the next time step (i.e., [symbol] +1 time step), which correspond to the field values 842, [symbol] . The gradients 844 are utilized to determine

$$\frac{\partial L}{\partial {x}_{i}}$$

for the backpropagation (e.g., update operation 832 backwards in time), which combined with the gradients 846 are used, at least in part, to calculate the structural gradient,

$$\frac{dL}{dz} \cdot \frac{\partial L}{\partial {x}_{i}}$$

is the contribution of each field to the loss metric, L. It is noted that this is the partial derivative, and therefore does not take into account the causal relationship of [symbol] → [symbol] . Thus,

$$\frac{\partial {x}_{i + 1}}{\partial {x}_{i}}$$

is utilized which encompasses the [symbol] → [symbol] relationship. The loss gradient,

$$\frac{dL}{{dx}_{i}} ,$$

may also be used to compute the structural gradient,

$$\frac{dL}{dz} ,$$

and corresponds to the total derivative of the field with respect to loss value, L. The loss gradient,

$$\frac{dL}{{dx}_{i}} ,$$

at a particular time step, [symbol] , is equal to the summation of

$$\frac{\partial L}{\partial {x}_{i}} + \frac{dL}{{dx}_{i + 1}} \frac{\partial {x}_{i + 1}}{\partial {x}_{i}} .$$

### Finally,

$$\frac{\partial {x}_{i}}{\partial z} ,$$

which corresponds to the field gradient, is used which is the contribution to

$$\frac{dL}{dz}$$

from each time/update step.

In particular, the memory footprint to directly compute

$$\frac{\partial L}{\partial {x}_{i}} and \frac{dL}{dz}$$

is so large that it is difficult to store more than a handful of state Tensors. The state Tensor corresponds to storing the values of all of the FDTD cells (e.g., the plurality of voxel) for a single simulation time step. It is appreciated that the term “tensor” may refer to tensors in a mathematical sense or as described by the TensorFlow framework developed by Alphabet, Inc. In some embodiments the term “tensor” refers to a mathematical tensor which corresponds to a multidimensional array that follows specific transformation laws. However, in most embodiments, the term “tensor” refers to TensorFlow tensors, in which a tensor is described as a generalization of vectors and matrices to potentially higher dimensions (e.g., n-dimensional arrays of base data types), and is not necessarily limited to specific transformation laws. For example, for the general loss function ƒ, it may be necessary to store the fields, xᵢ, for all time steps, i. This is because, for most choices of ƒ, the gradient will be a function of the arguments of ƒ. This difficulty is compounded by the fact that the values of

$$\frac{\partial L}{\partial {x}_{i}}$$

for larger values of i are needed before the values for smaller i due to the incremental updates of the field response and/or through backpropagation of the loss metric, which may prevent the use of schemes that attempt to store only the values

$$\frac{\partial L}{\partial {x}_{i}} ,$$

at an immediate time step.

An additional difficulty is further illustrated when computing the structural gradient,

$$\frac{dL}{dz} ,$$

which is given by:

$$\frac{dL}{dz} = \frac{dL}{d} \frac{\partial {x}_{i}}{\partial z} .$$

For completeness, the full form of the first term in the sum,

$$\frac{dL}{dz} ,$$

is expressed as:

$$\frac{dL}{d} = \frac{\partial L}{\partial {x}_{i}} + \frac{dL}{{dx}_{i + 1}} \frac{\partial {x}_{i + 1}}{\partial {x}_{i}}$$

Based on the definition of ϕ as described by equation (1), it is noted that

$$\frac{\partial {x}_{i + 1}}{\partial {x}_{i}} = A ( z ) ,$$

which can be substituted in equation (3) to arrive at an adjoint update for backpropagation (e.g., the update operations such as update operation 832), which can be expressed as:

$$\frac{dL}{{dx}_{i}} = \frac{\partial L}{\partial {x}_{i}} + \frac{dL}{{dx}_{i + 1}} A ( z ) ,$$

$$or$$

$${∇}_{{x}_{i}} L = {A ( z )}^{T} {∇}_{{x}_{i + 1}} L + \frac{\partial {L}^{T}}{\partial }$$

The adjoint update is the backpropagation of the loss gradient (e.g., from the loss metric) from later to earlier time steps and may be referred to as a backwards solve for

$$\frac{dL}{{dx}_{i}} .$$

More specifically, the loss gradient may initially be based upon the backpropagation of a loss metric determined from the operational simulation with the loss function. The second term in the sum of the structural gradient,

$$\frac{dL}{dz} ,$$

corresponds to the field gradient and is denoted as:

$$\frac{\partial {x}_{i}}{\partial z} = \frac{d ϕ ( {x}_{i - 1} , , z )}{dz} = \frac{dA ( z )}{dz} {x}_{i - 1} + \frac{dB ( z )}{dz} ,$$

for the particular form of ϕ described by the first equation above. Thus, each term of the sum associated

$$\frac{dL}{dz}$$

depends on both

$$\frac{dL}{{dx}_{{i}_{0}}}$$

for [symbol] > [symbol] ₀ and [symbol] for [symbol] < [symbol] ₀. Since the dependency chains of these two terms are in opposite directions, it is concluded that computing

$$\frac{dL}{dz}$$

in this way requires the storage of [symbol] values for all of [symbol] . In some embodiments, the need to store all field values may be mitigated by a reduced representation of the fields.

In previous techniques, the initial design 836 may be parameterized directly using voxels 712 to represent both the initial design 836 and the structural parameters 808. While voxel-based parameterization can lead to non-intuitive and detailed designs such as those illustrated in FIG. 4A and FIG. 4B, the computational complexity introduced by this parameterization in performing tasks such as checking for fabricability and applying gradient-based updates can make their use cost-prohibitive in terms of both time and computing resource requirements.

In some embodiments of the present disclosure, instead of using a voxel-based parameterization that uses a complete evaluation of each voxel in the design for fabricability and structural updates, the initial design is parameterized using one or more geometric shape primitives to represent features within the design region, where each geometric shape primitive is large in comparison to the voxels of the structural parameters (e.g., each geometric shape primitive touches four or more voxels). By using significantly fewer geometric shape primitives than the voxels of the structural parameters, the computing resources used to optimize the design are greatly reduced. Further, it has been found that the use of geometric shape primitives can cause the performance loss value to converge after fewer iterations of the optimization loop compared to the more detailed voxel-based parameterization.

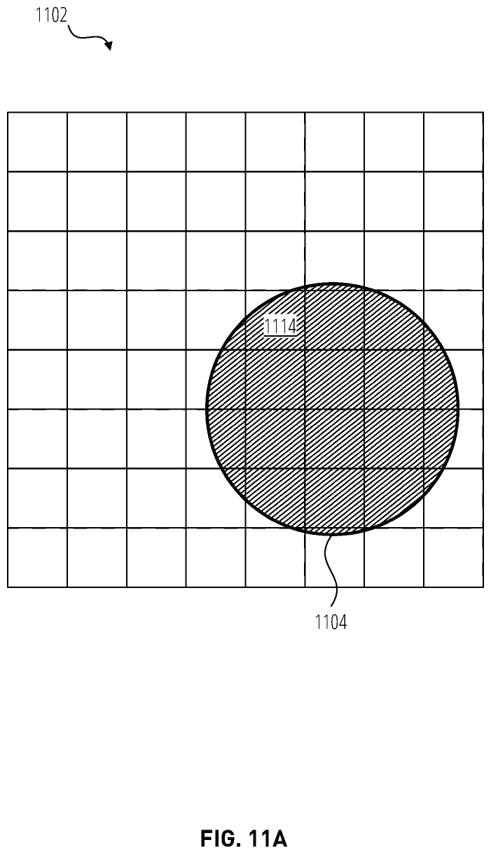

FIG. 9 is a schematic illustration of a non-limiting example embodiment of a parameterization of an initial design that uses geometric shape primitives to represent features, according to various aspects of the present disclosure. In FIG. 9, the initial design includes a design region 902, and the structures within the design region 902 are described by a plurality of geometric shape primitives 904-926. One will recognize that the initial design that includes the design region 902 may include other features, including but not limited to one or more input ports and/or one or more output ports. These features are illustrated in other drawings, but have not been illustrated in FIG. 9 to avoid obscuring other aspects of the disclosed subject matter.

In the illustrated embodiment, the geometric shape primitives 904-926 are circles. In other embodiments, other types of geometric shape primitives may be used, including but not limited to rectangles, higher-order polygons, ellipses, or other types of geometric shape primitives. In some embodiments, the perimeter of features may be specified by one or more splines instead of contiguous shapes, though other processing may occur as otherwise discussed herein. As will be seen, using circles (or other simple geometric shapes) as geometric shape primitives 904-926 to represent features within the design can lead to various efficiencies. For example, each of the geometric shape primitives 904-926 can be defined uniquely within the design region 902 with a small set of feature parameter values. For example, the geometric shape primitive 926 is labeled with a set of feature parameter values that includes its defining data points: a set of coordinates of a center of the geometric shape primitive 926 within a plane of the design region 902, illustrated as {x_{c}⁽ⁱ⁾, y_{c}⁽ⁱ⁾}, and a radius of the geometric shape primitive 926, illustrated as r_{c}⁽ⁱ⁾. As can be seen, the entire geometric shape primitive 926 can be represented by a set of feature parameter values that includes these three scalar values. This is a vast improvement over the voxel-based parameterization, in which each voxel within the geometric shape primitive 926 would be represented with its own value.

While the geometric shape primitives 904-926 are illustrated as circles represented by a set of feature parameter values that includes center coordinate values and radius values, one will recognize that other types of geometric shape primitives may similarly be represented by sets of feature parameter values that include a relatively small number of scalar values. For example, features may be represented by polygons, wherein each polygon is represented by a set of feature parameter values that includes vertex coordinate values with values for each of the vertices of the polygon. As another example, features may be represented by ellipses, wherein each ellipse is represented by a set of feature parameter values that includes a pair of focus coordinate values, a minor axis size value, and a major axis size value (or other appropriate values for representing ellipses). As yet another example, the perimeters of features may be represented by one or more splines, wherein each spline is represented by a set of feature parameter values that includes a set of knot vector values and a set of coefficient values.

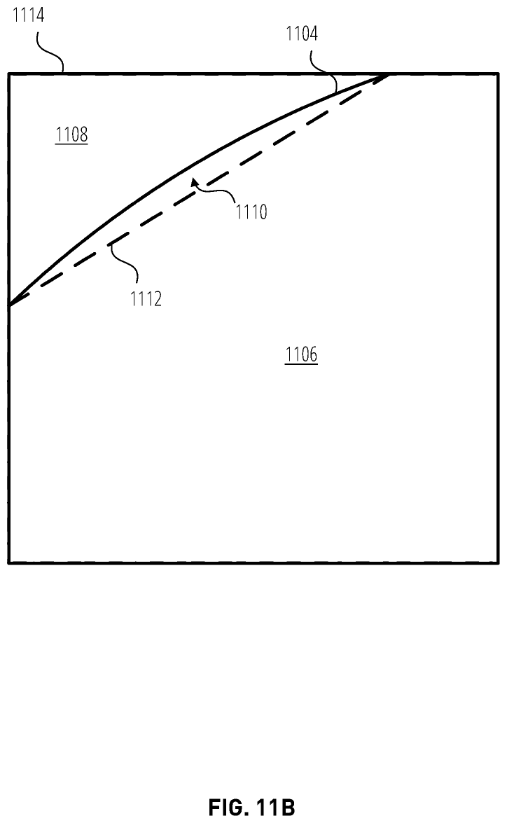

FIG. 10 is a flowchart that illustrates a non-limiting example embodiment of a method 1000 for generating a design of physical device such as a photonic integrated circuit using geometric shape primitives, in accordance with various aspects of the present disclosure. It is appreciated that method 1000 is an inverse design process that may be accomplished by performing operations with a system to perform iterative gradient-based optimization of a loss metric determined from a loss function that includes at least a performance loss, similar to that illustrated and described in FIG. 8A and FIG. 8B. In the same or other embodiments, method 1000 may be included as instructions provided by at least one machine-accessible storage medium (e.g., non-transitory memory) that, when executed by a machine, will cause the machine to perform operations for generating and/or improving the design of the physical device. It is further appreciated that the order in which some or all of the process blocks appear in method 1000 should not be deemed limiting. Rather, one of ordinary skill in the art having the benefit of the present disclosure will understand that some of the process blocks may be executed in a variety of orders not illustrated, and/or in parallel.

From a start block, the method 1000 proceeds to block 1002, where a design specification of a physical device such as a photonic integrated circuit is received. In some embodiments, the physical device may be expected to have a certain functionality (e.g., perform as an optical demultiplexer, an optical multiplexer, an optical waveguide bend, or another type of optoelectronic component) after optimization. In some embodiments, the design specification may indicate an overall structure of the physical device (e.g., dimensions of a design region, initial locations and numbers of one or more input ports and/or one or more output ports), desired performance of the device (e.g., desired performance characteristics at each input port and/or output port), one or more fabricability constraints (e.g., a minimum feature size, a minimum distance, a boundary buffer size, etc.) associated with a fabrication system to be used to fabricate the physical device, and/or any other relevant specification.

At block 1004, an initial design 836 is generated that includes one or more geometric shape primitives based on the design specification. In some embodiments, the type of geometric shape primitive (e.g., circle, square, rectangle, higher-order polygon, spline, ellipse, etc.) may be indicated by the design specification. In some embodiments, a number of geometric shape primitives to be included in the initial design 836 may be indicated in the design specification. In some embodiments, the geometric shape primitives may be randomly sized and randomly positioned within the design region of the initial design 836. In some embodiments, the geometric shape primitives of the initial design 836 may be of a default size and/or positioned at default or regular positions within the design region of the initial design 836. In some embodiments, the geometric shape primitives of the initial design 836 may be arranged to comply with the fabricability constraints associated with the fabrication system. In some embodiments, the geometric shape primitives may be arranged regardless of the fabricability constraints, with fabricability to be achieved during the optimization process.

While using geometric shape primitives to parameterize the design region greatly simplifies the search space to be analyzed during the inverse design process, one problem arises in that the geometric shape primitives themselves are poorly differentiable. In other words, while the number of parameters to be optimized for geometric shape primitives is much lower than if individual voxel within the design region are optimized, a gradient of the loss metric does not backpropagate well to the geometric shape primitives themselves due to their discrete (not continuous) nature, and so it is desirable to use an intermediate, continuous representation to convert the geometric shape primitives to structural parameters to be simulated in order to improve differentiability. Accordingly, at block 1006, a signed distance field is determined for each of the geometric shape primitives. In some embodiments, the signed distance field is determined analytically. For an example that uses circular geometric shape primitives, for each voxel x, y within the signed distance field for a circular geometric shape primitive with a center x_{c}, y_{c} and radius r, the value of the voxel may be given as:

$$SDF ( x , y ) = r - \sqrt{{\vert {x}_{c} - x \vert}^{2} + {\vert {y}_{c} - y \vert}^{2}}$$

Signed distance fields for other types of geometric shape primitives may be determined analytically using other techniques appropriate to the type of geometric shape primitive.

At block 1008, each signed distance field is projected onto a density field to determine a set of structural parameters 808. In some embodiments, the density field may be of a size that matches the size of the design region and may include voxels similar to the voxels 712 of the simulated environment 706 illustrated above. Values at corresponding positions of each signed distance field may be added to the corresponding voxel of the density field, such that all of the signed distance fields are combined into the single density field to create the structural parameters 808 for the simulated environment 706. After combination, a step of binarization may take place such that negative values may be set to a value of zero, and positive values may be set to a value of one, to indicate the presence or absence of a given material for the set of structural parameters 808. In some embodiments, some values within a threshold range of zero may be assigned a real value between zero and one to indicate a partial amount of the voxel to be filled with the given material. In some embodiments, instead of a hard threshold, the values of the density map may be passed through a sigmoid function to assign most values within the density map to zero or one, but to leave a differentiable transition region close to zero so that gradients can pass through the density map during optimization.

Within the simulated environment 706, each of the plurality of voxels is associated with a structural value to describe the structural parameters, field values to describe the field response (e.g., the electric and magnetic fields in one or more orthogonal directions) to physical stimuli (e.g., one or more excitation sources), and a source value to describe the physical stimuli.

At block 1010, a simulated environment 706 is configured to be representative of the set of structural parameters 808. Once the structural parameters 808 are determined, the simulated environment 706 is configured (e.g., the number of voxels, shape/arrangement of voxels, and specific values for the structural value, field values, and/or source value of the voxels are set based on the structural parameters 808).

In some embodiments the simulated environment includes a design region optically coupled between a first communication region and a plurality of second communication regions. In some embodiments, the first communication region may correspond to an input region or port (e.g., where an excitation source originates), while the second communication may correspond to a plurality of output regions or ports (e.g., when designing an optical demultiplexer that optically separates a plurality of distinct wavelength channels included in a multi-channel optical signal received at the input port and respectively guiding each of the distinct wavelength channels to a corresponding one of the plurality of output ports). However, in other embodiments, the first communication region may correspond to an output region or port, while the plurality of second communication regions corresponds to a plurality of input ports or region (e.g., when designing an optical multiplexer that optically combines a plurality of distinct wavelength signals received at respective ones of the plurality of input ports to form a multi-channel optical signal that is guided to the output port).

At block 1012, each of a plurality of distinct wavelength channels are mapped to a respective one of the plurality of second communication regions. The distinct wavelength channels may be mapped to the second communication regions by virtue of the design specification. For example, a loss function may be chosen that associates a performance metric of the physical device with power transmission from the input port to individual output ports for mapped channels. In one embodiment, a first channel included in the plurality of distinct wavelength channels is mapped to a first output port, meaning that the performance metric of the physical device for the first channel is tied to the first output port. Similarly, other output ports may be mapped to the same or different channels included in the plurality of distinct wavelength channels such that each of the distinct wavelength channels is mapped to a respective one of the plurality of output ports (i.e., second communication regions) within the simulated environment 706. In one embodiment, the plurality of second communication regions includes four regions and the plurality of distinct wavelength channels includes four channels that are each mapped to a corresponding one of the four regions. In other embodiments, there may be a different number of the second communication regions (e.g., 8 regions) and a different number of channels (e.g., 8 channels) that are each mapped to a respective one of the second communication regions. In some embodiments, only a single input port and a single output port may be included, such as for waveguide bends or other devices intended to change a direction of an incoming signal to another direction.

Subroutine block 1014 illustrates performing an operational simulation 802 of the physical device within the simulated environment 706 operating in response to one or more excitation sources to determine a performance loss value 822. More specifically, in some embodiments an electromagnetic simulation is performed in which a field response of the photonic integrated circuit is updated incrementally over a plurality of time steps to determine how the how the field response of the physical device changes due to the excitation source. The field values of the plurality of voxels are updated in response to the excitation source and based, at least in part, on the structural parameters 808 of the integrated photonic circuit. Additionally, each update operation at a particular time step may also be based, at least in part, on a previous (e.g., immediately prior) time step.

Consequently, the operational simulation 802 simulates an interaction between the photonic device (i.e., the photonic integrated circuit) and a physical stimuli (i.e., one or more excitation sources) to determine a simulated output of the photonic device (e.g., at one or more of the output ports or regions) in response to the physical stimuli. The interaction may correspond to any one of, or combination of a perturbation, retransmission, attenuation, dispersion, refraction, reflection, diffraction, absorption, scattering, amplification, or otherwise of the physical stimuli within electromagnetic domain due, at least in part, to the structural parameters 808 of the photonic device and underlying physics governing operation of the photonic device. Thus, the operational simulation 802 simulates how the field response of the simulated environment 706 changes due to the excitation source over a plurality of time steps (e.g., from an initial to final time step with a pre-determined step size).

In some embodiments, the simulated output may be utilized to determine one or more performance metrics of the physical device. For example, the excitation source may correspond to a selected one of a plurality of distinct wavelength channels that are each mapped to one of the plurality of output ports. The excitation source may originate at or be disposed proximate to the first communication region (i.e., input port) when performing the operational simulation 802. During the operational simulation 802, the field response at the output port mapped to the selected one of the plurality of distinct wavelength channels may then be utilized to determine a simulated power transmission of the photonic integrated circuit for the selected distinct wavelength channel. In other words, the operational simulation 802 may be utilized to determine the performance metric that includes determining a simulated power transmission of the excitation source from the first communication region, through the design region, and to a respective one of the plurality of second communication regions mapped to the selected one of the plurality of distinct wavelength channels. In some embodiments, the excitation source may cover the spectrum of all of the plurality of output ports (e.g., the excitation source spans at least the targeted frequency ranges for the bandpass regions for each of the plurality of distinct wavelength channels as well as the corresponding transition band regions, and at least portions of the corresponding stopband regions) to determine a performance metric (i.e., simulated power transmission) associated with each of the distinct wavelength channels for the photonic integrated circuit. In some embodiments, one or more frequencies that span the passband of a given one of the plurality of distinct wavelength channels is selected randomly to optimize the design (e.g., batch gradient descent while having a full width of each passband including ripple in the passband that meets the target specifications). In the same or other embodiments, each of the plurality of distinct wavelength channels has a common bandwidth with different center wavelengths. The performance metric may then be used to generate a performance loss value for the initial design 836. The performance loss value may correspond to a difference between the performance metric and a target performance metric of the physical device.

Though a single initial design 836 and single set of structural parameters 808 is described above, in some embodiments, the initial design 836 may be perturbed to create a plurality of initial designs 806 in order to, for example, simulate the effects of different operating conditions for the fabrication system during fabrication of the physical device. Each of the plurality of initial designs 806 may be used to create structural parameters 808 and generate performance loss values. The performance loss values may be combined into a single loss metric 824, which may then be used to update the initial design 836.

In some embodiments, the loss metric 824 may include terms in addition to the performance loss value in order to optimize different aspects of the initial design 836. For example, in some embodiments, a term for a fabrication loss value may be included in the loss metric 824. One advantage of the use of geometric shape primitives is the particular ease with which compliance fabrication constraints can be determined and included within the loss metric 824.

Block 1016 illustrates backpropagating the loss metric 824 via the loss function through the simulated environment 706 to determine an influence of changes in the structural parameters 808 on the loss metric (i.e., structural gradient). The loss metric is treated as an adjoint or virtual source and is backpropagated incrementally from a final time step to earlier time steps in a backwards simulation to determine the structural gradient of the physical device.

Block 1018 shows revising the design of the physical device (e.g., generated a revised description) by updating the geometric shape primitives using the signed distance fields to adjust the loss metric. The backpropagation is first applied to the structural parameters, from the structural parameters to the density field, from the density field to the signed distance fields, and from the signed distance fields to the sets of feature parameter values defining the geometric shape primitives of the initial design 836. By using differentiable functions to convert from geometric shape primitives to signed distance fields, the gradients can flow all the way back to the geometric shape primitives. In other words, the optimizer obtains

$$\frac{dL}{d \{ r , {x}_{c} , {y}_{c} \}}$$

via:

$$\frac{dL}{d \{ r , {x}_{c} , {y}_{c} \}} = \frac{dL}{d SDF} \cdot \frac{d SDF}{d \{ r , {x}_{c} , {y}_{c} \}} ,$$

$$with \frac{d SDF}{d \{ r , {x}_{c} , {y}_{c} \}}$$

being obtainable from the analytic function defining the values for the signed distance field provided above.

In some embodiments, adjusting for the loss metric may reduce the loss metric. However, in other embodiments, the loss metric may be adjusted or otherwise compensated in a manner that does not necessarily reduce the loss metric. In some embodiments, the revised description is generated by utilizing an optimization scheme after a cycle of operational and adjoint simulations via a gradient descent algorithm, Markov Chain Monte Carlo algorithm, or other optimization techniques. Put in another way, iterative cycles of simulating the physical device, determining a loss metric, backpropagating the loss metric, updating the structural parameters to adjust the loss metric, and updating the geometric shape primitives using the signed distance fields may be successively performed until the loss metric substantially converges such that the difference between the performance metric and the target performance metric is within a threshold range. In some embodiments, the term “converges” may simply indicate the difference is within the threshold range and/or below some threshold value.

At decision block 1020, a determination is made regarding whether optimization of the design of the physical device is done. In some embodiments, optimization of the design of the physical device may be done when it is determined that the loss metric 824 has reached an acceptable value, such as a value specified by the design specification. In some embodiments, optimization of the design of the physical device may be done after a predetermined number of iterations.

If the determination is that optimization is not yet done, then the result of decision block 1020 is NO, and the method 1000 returns to block 1006 to iterate on the updated geometric shape primitives. Otherwise, if the determination is that optimization is done, then the result of decision block 1020 is YES and the method 1000 advances to block 1022.

Block 1022 illustrates outputting the updated design of the physical device. The updated design may be output to a computer-readable medium for storage and later operations, including but not limited to fabrication, further optimization, or inclusion in additional designs. In some embodiments, the updated design may be output to a fabrication system for fabrication of the physical device. In some embodiments, the updated design may be output to the fabrication system by providing a grid of voxel that each indicate a material to be included at a corresponding position of the physical device. In some embodiments, the updated design may be output to the fabrication system by outputting the list of geometric shape primitives itself, which may then be ingested by the fabrication system for fabricating the physical device.

The method 1000 then proceeds to an end block and terminates.

In implementing inverse design techniques such as those discussed above to create optoelectronic devices (and other physical devices), the accuracy of the operational simulation has a significant effect on the success of the overall design. While FDTD can often be an effective simulation technique due to its scalability, it can also exhibit some issues with regard to accuracy. For example, designs such as the design illustrated in FIG. 9 that are parameterized by curved shapes tend to have features that do not align with the borders of the voxels being simulated.

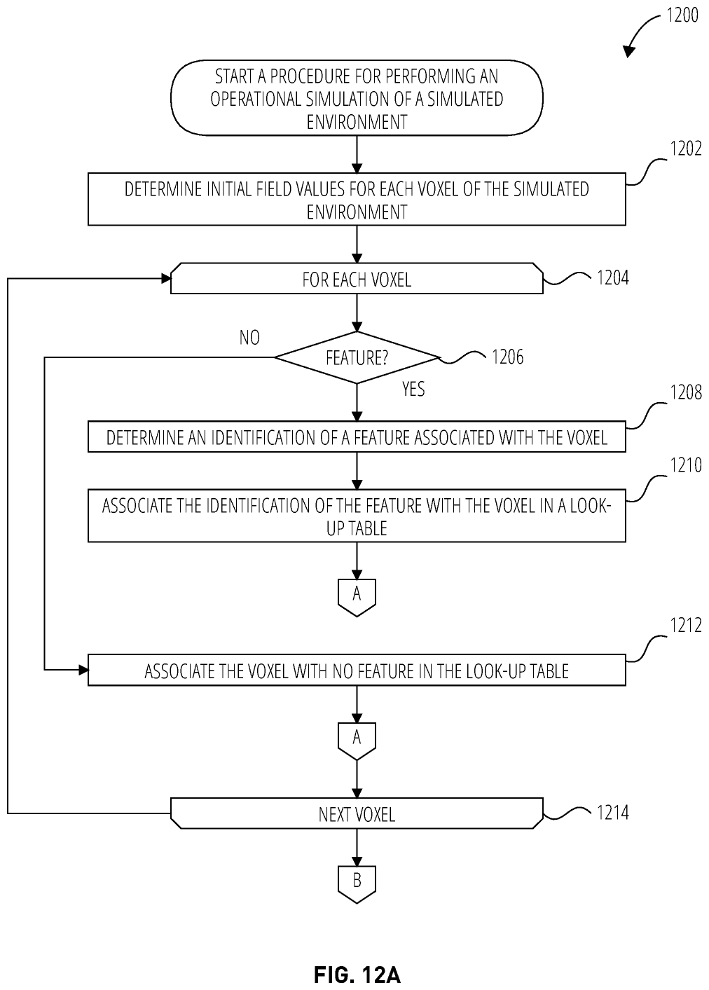

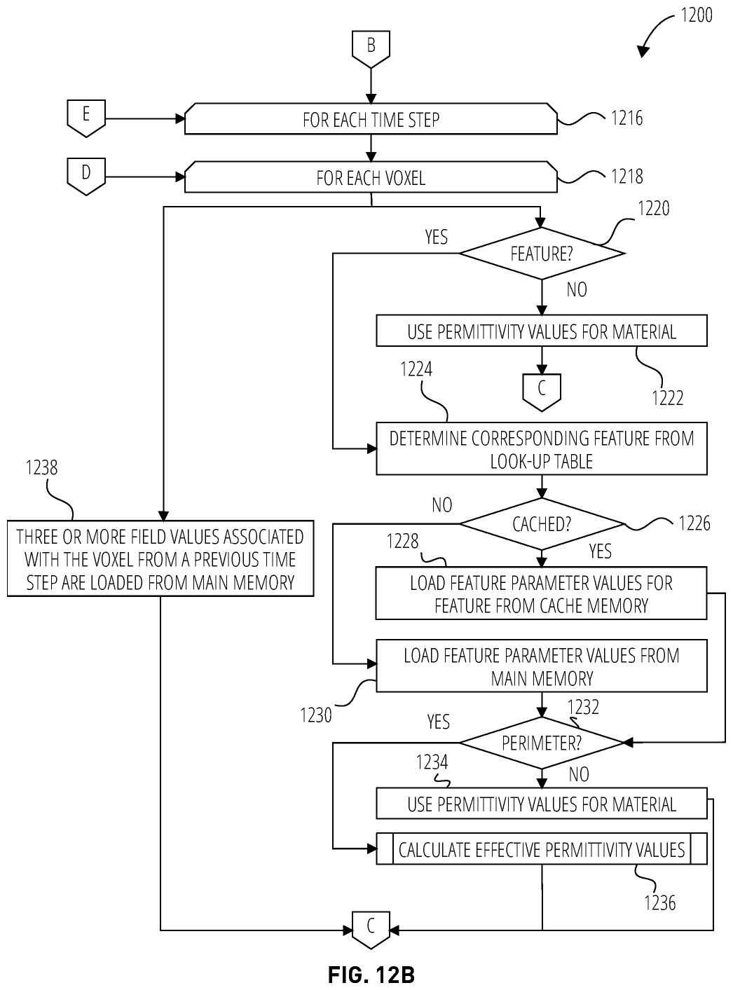

FIG. 11A is a schematic illustration of a non-limiting example embodiment of a set of voxels 1102 that include a curved feature according to various aspects of the present disclosure. As can be seen, eight of the voxels that make up the curved feature (circle 1104) are entirely within the circle, but eighteen voxels (such as voxel 1114) include a boundary between the circle 1104 and the background material, represented by the perimeter of the circle 1104. In Maxwell's equations, boundaries present a discontinuity, but because of Yee's mesh (which is used to solve Maxwell's equations in an FDTD solve), values in a neighboring voxel are considered, a difference is obtained, and a derivative is approximated. While this creates a slope between sampled points, the boundaries should be more accurately simulated as a sharp line at the exact boundary. Accordingly, these boundary voxels are one order lower in convergence accuracy than voxels that only include a single material, and so the accuracy of the simulation is dominated by this boundary.

Increasing the resolution of the grid of voxels can help increase the accuracy, but doubling the resolution of the grid results in an O(n⁴) increase in the amount of work, for only an O(n²) (or even merely linear) increase in accuracy. What is desirable are techniques that can improve accuracy of the FDTD simulation for boundary voxels that include more than one material.

One existing technique for increasing the accuracy of FDTD simulations is subpixel smoothing. In subpixel smoothing techniques, effective permittivity values are determined for boundary voxels based on the relative amounts of a first material and a second material in the voxels, along with a surface normal vector and a surface tangent vector for the interface between the first material and the second material. The effective permittivity values are used during the FDTD solve for the voxel instead of the specific permittivity values for the first material or the second material in order to more accurately model the interface within the boundary voxel. While existing subpixel smoothing techniques do somewhat improve the accuracy for FDTD simulations, they merely approximate the effective permittivity values, and thus do not fully compensate for the inaccuracies in simulating the boundary voxels.

FIG. 11B is a schematic illustration of a boundary voxel that shows sources of inaccuracy with existing subpixel smoothing techniques. As shown in FIG. 11A, the voxel 1114 includes a boundary between a first material 1108 and a second material 1106 defined the perimeter of a circle 1104 that passes through the voxel 1114. In existing subpixel smoothing techniques, the volume fraction of materials within the voxel 1114 is determined by drawing an approximation line 1112 between points on the edges of the voxel 1114 where the circle 1104 crosses the edges, and using the approximation line 1112 to determine the volume fraction, surface normal vector, and surface tangent vector. While the use of an approximation line 1112 does allow an approximate volume fraction to be efficiently calculated, it nevertheless leaves an error region 1110 between the circle 1104 and the approximation line 1112 that causes the volume fraction (and, consequently, the effective permittivity values) to be inaccurate.

In embodiments of the present disclosure, the parameterization of features in the design is leveraged in order to analytically determine precise volume fractions, surface normal vectors, and surface tangent vectors, thus eliminating the error introduced by the error region 1110 in previous attempts at subpixel smoothing. Further (and as discussed in more detail below), by computing the effective permittivity values during the simulation while field values are being loaded from main memory 612, these analytical computations can be performed without unduly impacting the overall length of time needed for the operational simulation.

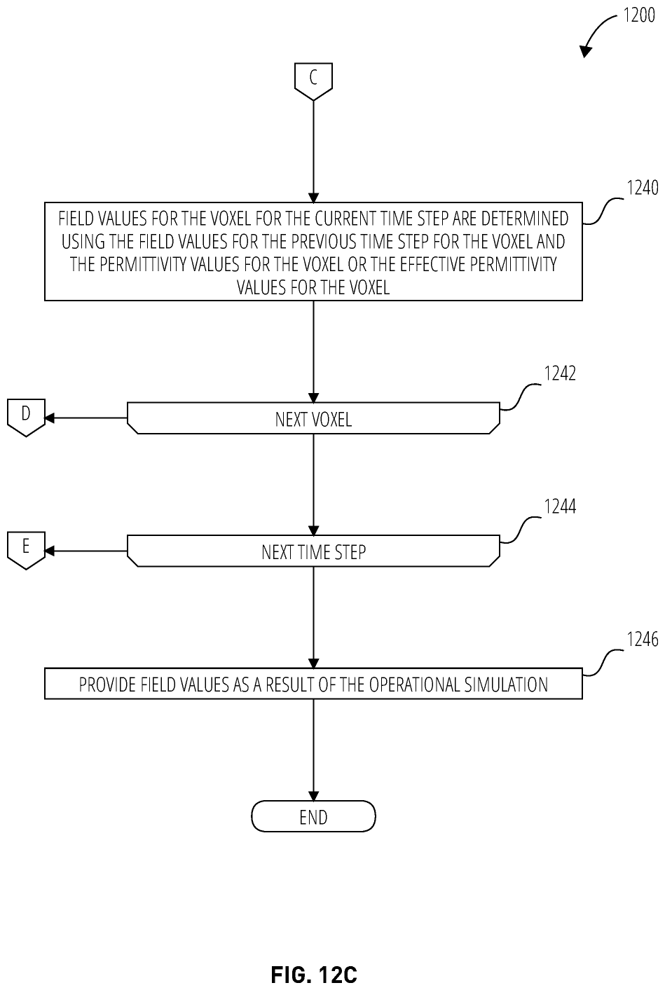

FIG. 12A-FIG. 12C are a flowchart that illustrates a non-limiting example embodiment of a procedure 1200 for performing an operational simulation of a simulated environment according to various aspects of the present disclosure. The procedure 1200 is a non-limiting example of a procedure suitable for use for performing an operational simulation at subroutine block 1014 of FIG. 10. In some embodiments, the procedure 1200 may be executed by operational simulation engine 526 of the controller 512 illustrated in FIG. 5 and described in detail above.

In the procedure 1200, it is assumed that the design region being simulated is parameterized by a plurality of features represented by geometric shape primitives (such as, for example, the circles illustrated in FIG. 9, or any other type of geometric shape primitive represented by a suitable set of feature parameter values). The sets of feature parameter values used to define the features within the design region are used to analytically determine highly accurate values for use in subpixel smoothing, thus providing improved accuracy compared to previous subpixel smoothing techniques. Further, by analytically determining the values during the delay caused by loading field values from main memory 612, the impact of the additional computations on the overall time spent during the operational simulation (i.e., the overall wall clock time) is negligible. This provides a significant benefit over previous techniques for increasing the accuracy of FDTD simulations. Such previous techniques increased accuracy by increasing the resolution of the voxels in the design area, thus exponentially increasing the length of the simulation for only a linear increase in accuracy (as described above). In comparison, the techniques described in procedure 1200 increase the accuracy with only a negligible increase, if any, in the time used for the simulation.

From a start block, the procedure 1200 advances to block 1202, where initial field values for each voxel of the simulated environment are determined. In some embodiments, the initial field values assume no stimulus or source has yet been applied, and so the initial field values may be based simply on intrinsic properties of the first material and the second material. In some embodiments, a two-dimensional simulation is conducted, and so field values are determined (and simulated within the procedure 1200) for a horizontal axis (x values) and a vertical axis (y values), but not for a height axis (z values). The two-dimensional simulation uses the assumption that the features of the design are extruded in the z direction, and so behavior along the z axis may be ignored. In some embodiments, a three-dimensional simulation is conducted, and so field values are determined and simulated for each of the x, y, and z axes.

The procedure 1200 then advances to a for-loop defined between for-loop start block 1204 and for-loop end block 1214, wherein each voxel of the simulated environment is pre-processed to determine how permittivity values for the voxel should be determined by the procedure 1200—whether the voxel contains any part of a feature and so should have a permittivity value based on an amount of the feature material that is present in the voxel, or whether the voxel does not contain any part of a feature and so should have the permittivity value of the other material. The result of the for-loop is a look-up table that includes entries for each voxel, wherein each entry either indicates that the voxel is not associated with any feature, or indicates which feature from a list of features that the voxel is associated with (i.e., at least a portion of the feature is located within the voxel). This for-loop does process every voxel, but since the for-loop is only executed once per operational simulation and executes in linear time with respect to the size of the design region, the length of time of the operational simulation is not significantly increased by the for-loop since the overall time of the operational simulation is dominated by the processing of the time steps described below.

From the for-loop start block 1204, the procedure 1200 advances to a decision block 1206, where a determination is made regarding whether the voxel is part of a geometric shape primitive that parameterizes a feature in the design. In some embodiments, the determination is made analytically using the set of feature parameter values for each feature of the design, along with the coordinates of the voxel. In some embodiments, for each feature the coordinates of each electric or magnetic field component of the voxel are checked to determine whether they are inside or outside of the feature. If at least one corner of the voxel is inside a feature, then the voxel is determined to be part of a feature. The procedure 1200 assumes that the features are large compared to individual voxels, and so it would not be expected for a feature to be located entirely within a single voxel (i.e., all of the corners of the voxel being outside of the feature, yet the voxel still containing a feature). The procedure 1200 may also assume that each voxel is associated with at most one feature. Since a minimum distance fabrication constraint (i.e., a minimum distance to be maintained between features in order for the design to be fabricable) is likely to be larger than a single voxel, assuming that each voxel is associated with at most one feature does not exclude a significant amount of the fabricable design space from consideration.

If it is determined that the voxel is part of a feature, then the result of decision block 1206 is YES, and the procedure 1200 advances to block 1208, where an identification of a feature associated with the voxel is determined. In some embodiments, the feature that the voxel is associated with is determined during decision block 1206, and the identification of the feature (e.g., feature #5 out of a list of features in the design) is recorded at block 1208. In some embodiments, the actions of block 1208 occur during decision block 1206, but are illustrated as separate boxes for the sake of clarity.

Once determined, at block 1210, the identification of the feature is associated with the voxel in a look-up table. In some embodiments, the identification of the feature is stored in the look-up table along with an identification of the voxel (e.g., coordinates that define the voxel, a numerical identifier of the voxel, or another value that links the voxel to the feature). In some embodiments, instead of storing the identification of the feature, the set of feature parameter values are stored directly in the look-up table. The procedure 1200 then advances to a continuation terminal (“terminal A”).

Returning to decision block 1206, if the voxel is not associated with a feature, then the result of decision block 1206 is NO, and the procedure 1200 advances to block 1212. At block 1212, the voxel is associated with no feature in the look-up table. In some embodiments, a single bit indicating whether the voxel is associated with a feature may be stored in the look-up table in order to reduce the size of the look-up table, and associating the voxel with no feature includes setting this bit to an appropriate value. In some embodiments, storing a null value or other default value in the look-up table that is not associated with a feature, instead of an identifier of a feature, may be used instead of a separate value that indicates whether or not the voxel is associated with any feature. The procedure 1200 then advances to a continuation terminal (“terminal A”).

From terminal A, the procedure 1200 advances to the for-loop end block 1214. If further voxels remain to be pre-processed, then the procedure 1200 returns to the for-loop start block 1204 to process the next voxel. Otherwise, if all of the voxels have been pre-processed, then the procedure 1200 advances from for-loop end block 1214 to another continuation terminal (“terminal B”). One of skill in the art will note that although the for-loop between for-loop start block 1204 and for-loop end block 1214 was illustrated with a decision block and multiple other blocks representing various actions being taken, this particular illustration of the logic is used for the sake of clarity and should not be seen as limiting. In some embodiments, decision block 1206 and/or other blocks of the for-loop may be combined with each other, such that the described actions may be performed in fewer steps than those illustrated.

From terminal B (FIG. 12B), the procedure 1200 advances to a time step loop defined between time step loop start block 1216 and time step loop end block 1244 (FIG. 12C), in which a time step of the operational simulation is conducted. In each time step, field values for each voxel in the simulated environment are determined for the current time step. At a high level, the time step loop describes the use of Yee's technique to determine the field values, as augmented by the use of subpixel smoothing techniques to improve accuracy of the simulation at material interfaces.

From the time step loop start block 1216, the procedure 1200 advances to a voxel loop defined between voxel loop start block 1218 and voxel loop end block 1242 (FIG. 12C), in which the field values for each voxel are determined based on the field values for the voxel from the previous time step (or the initial field values when processing the first time step), the sources for the voxel, and permittivity values for the voxel.

As discussed above, subpixel smoothing techniques can be helpful to improve the accuracy of the computation of the field values, and the sets of feature parameter values that define features of the design can be used to determine more precise effective permittivity values for subpixel smoothing than have been provided by previous subpixel smoothing techniques. However, if the effective permittivity values were precomputed for each voxel, the procedure 1200 would have to store a set of effective permittivity values for each voxel. This set of effective permittivity values for each voxel would be highly unlikely to fit in a cache memory because it would be far too large, and so the set of effective permittivity values would need to be loaded from main memory 612 at each time step for each voxel (as are the field values). Due to the slow nature of accessing main memory 612 (compared to accessing cache memory or performing computations on values stored in registers 604), precomputing and storing effective permittivity values for each voxel for use during each time step may be impractical, and/or may unduly slow down the procedure 1200.

In order to overcome this technical problem, some embodiments of the present disclosure take advantage of the sets of feature parameter values that define the features to calculate the effective permittivity values for each voxel on the fly instead of precomputing the effective permittivity values and loading them from main memory 612. The field values for a previous time step that are used to calculate the field values for the current time step are themselves stored in main memory 612, and so six field values (representing the fields in each coordinate axis for the voxel and/or adjacent voxels) are loaded from main memory 612 for every voxel. These values are highly unlikely to be present in cache memory, at least because each field value for each voxel is independent from the other field values, and none of the cache memory is likely to be large enough to store this amount of information for the entire simulated environment. Meanwhile, each feature is also defined by a set of feature parameter values (e.g., a set of center coordinate values and a radius value for a circle), but because neighboring voxels are likely to be associated with the same features, it is more likely that the set of feature parameter values defining a given feature for a voxel are present in cache memory, and can therefore be accessed highly efficiently. As such, some embodiments of the present disclosure take advantage in the delay caused by loading the field values from main memory 612 to compute the effective permittivity values on the fly, thus providing the more accurate data used in subpixel smoothing without significantly impacting execution time of the procedure 1200.

Accordingly, from the voxel loop start block 1218, the procedure 1200 concurrently advances to block 1238 and decision block 1220. The concurrent actions may be performed by separate processors, separate processing cores of the same processor, or using any other parallel computing technique known to those of ordinary skill in the art. At block 1238, three or more field values associated with the voxel from a previous time step are loaded from main memory 612. Updating some field values for some voxels involves loading complementary fields at the same and adjacent locations. For example, to update Eₓ for a voxel, the Eₓ value for the previous time step is used, along with neighbor differencing of the values of H_{y} (spanning two voxels in the z direction). This process is performed for each of the field components (e.g., Eₓ, E_{y}, E_{z}, Hₓ, H_{y}, H_{z}). Cyclic permutations and swapping E and H are used to obtain all six combinations. The resulting values are later multiplied by the material property (i.e., the permittivity value determined in blocks 1220-1236) to update the fields for the components, and by determining the permittivity value while loading the field values from main memory, significant accelerations in performance are obtained. After block 1238, the procedure 1200 advances from block 1238 to a continuation terminal (“terminal C”).

While the procedure 1200 is loading the field values between block 1238 and terminal C (the left side of FIG. 12B), the procedure 1200 is also processing the actions between decision block 1220 and terminal C (the right side of FIG. 12B). At decision block 1220, a determination is made regarding whether the voxel is associated with a feature of the set of features present in the design region. In some embodiments, the determination may be made by consulting the look-up table described above.

If it is determined that the voxel is not part of a feature, then the result of decision block 1220 is NO, and the procedure 1200 advances to block 1222, where the permittivity values for the first material are used. In embodiments wherein the first material and the second material are isotropic, a single permittivity value may be retrieved for the first material. In embodiments wherein the first material is anisotropic, different permittivity values may be retrieved for different coordinate axes. Since the permittivity values for the first material will remain constant, it is likely that these values will remain in cache memory when processing adjacent voxels and will not need to be repeatedly loaded from main memory 612. The procedure 1200 then advances to the continuation terminal (“terminal C”).

Otherwise, if it is determined that the voxel is associated with a feature, then the result of decision block 1220 is YES, and the procedure 1200 advances to block 1224. At block 1224, the corresponding feature is determined from the look-up table. The procedure 1200 then advances to decision block 1226, where a determination is made regarding whether a set of feature parameter values for the corresponding feature are present in cache memory. Typically, this determination is made automatically by cache management circuitry, but it is shown here as a separate action for the purposes of illustration.

If the set of feature parameter values for the corresponding feature are present in cache memory, then the result of decision block 1226 is YES, and the procedure 1200 advances to block 1228, where the set of feature parameter values for the corresponding feature are loaded from cache memory. As described above, loading these values from cache memory is very fast (on the order of 10s of clock cycles) compared to loading these values from main memory 612.

Otherwise, if the set of feature parameter values for the corresponding feature are not present in cache memory, then the result of decision block 1226 is NO, and the procedure 1200 advances to block 1230, where the set of feature parameter values for the corresponding feature are loaded from main memory 612. Though this is comparatively slow, it should happen relatively infrequently, depending on the order in which voxels are processed. For example, if voxels are processed row-by-row, then adjacent voxels are likely to be associated with either the same feature or with no feature, and so the result of decision block 1226 is likely to be NO just once per feature, per row of voxels (assuming convex features), because a plurality of voxels from the same feature or with no feature will be processed consecutively.

After the set of feature parameter values for the corresponding feature are loaded in either block 1228 or block 1230, the procedure 1200 advances to decision block 1232, where a determination is made regarding whether the voxel includes a boundary between the first material and the second material (e.g., whether a perimeter of the feature passes through the voxel). Any suitable technique may be used to determine whether the voxel includes a boundary. For example, if the feature is a circle, a distance between the coordinates of each of the vertices of the voxel and the set of center coordinate values may be determined, and if one or more of the vertices of the voxel are farther from the set of center coordinate values than the radius value of the circle (i.e., one or more of the vertices are outside of the circle), then it may be determined that the voxel does include a boundary. If all of the vertices are inside of the circle, then the voxel is completely within the circle and does not include a boundary. If all of the vertices are outside of the circle, then the voxel would not be associated with a circle, so decision block 1232 should not be reached. For features of other shapes, appropriate techniques for the shapes may be used to analytically determine whether the perimeter of the feature passes through the voxel. In some embodiments, the determination of whether the voxel includes a boundary may be pre-determined (such as at block 1208 or block 1210) and stored with the other information in the look-up table.

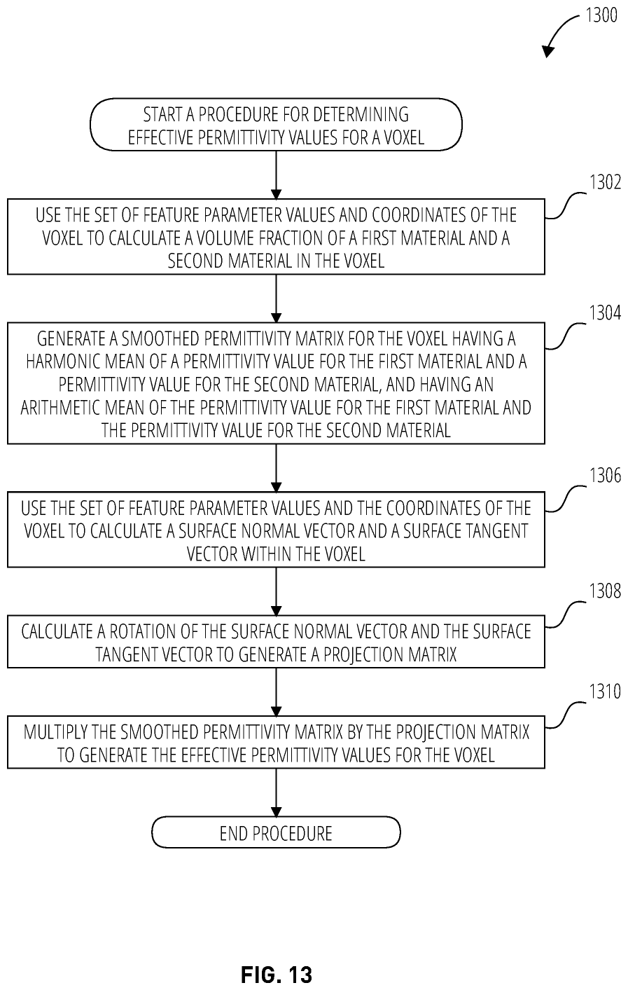

If it is determined that a boundary is not present within the voxel (i.e., the voxel is entirely within the feature), then the result of decision block 1232 is NO, and the procedure 1200 advances to block 1234, where permittivity values for the second material are used for the voxel, and the procedure 1200 advances to terminal C. Otherwise, if is determined that a boundary is present within the voxel, then the result of decision block 1232 is YES, and the procedure 1200 advances to subroutine block 1236, where a procedure is executed that calculates effective permittivity values for the voxel based on the set of feature parameter values and the permittivity values of the first material and the second material. Any suitable technique may be used for determining the effective permittivity values, including but not limited to the procedure 1300 illustrated in FIG. 13 and described in further detail below. The procedure 1200 then advances to the continuation terminal (“terminal C”).

From terminal C (FIG. 12C), the procedure 1200 advances to block 1240, where field values for the voxel for the current time step are determined using the field values for the previous time step for the voxel and either the permittivity values for the voxel (determined at block 1222 or block 1234) or the effective permittivity values for the voxel (determined at subroutine block 1236). Once appropriate permittivity values have been determined and the field values for the previous time step have been retrieved as described above, Yee's techniques (known to those of ordinary skill in the art) can be used to determine the field values for the voxel for the current time step. Once the field values for the current time step are determined, the procedure 1200 stores the field values for the current time step in memory. Typically, the values will first be written to cache memory, and will eventually be copied to main memory 612 according to the cache management strategy being used.

The procedure 1200 then advances to voxel loop end block 1242. If more voxels remain to be processed in the current time step, then the procedure 1200 returns to voxel loop start block 1218 via a continuation terminal (“terminal D”) to process the next voxel. Otherwise, if all of the voxels have been processed, then the procedure 1200 advances from voxel loop end block 1242 to time step loop end block 1244.

In some embodiments, the procedure 1200 may simulate a predetermined number of time steps. In some embodiments, the procedure 1200 executes time steps until a desired transient or steady-state field behavior is fully evolved. Accordingly, if more time steps remain to be processed, then the procedure 1200 returns to time step loop start block 1216 via a continuation terminal (“terminal E”) to simulate the next time step. Otherwise, if all of the time steps have been simulated, then the procedure 1200 advances from time step loop end block 1244 to block 1246.

At block 1246, the procedure 1200 provides the field values of the last time step as a result of the operational simulation. In some embodiments, the field values at the input port(s) and/or output port(s) may be used to determine scattering parameters (s-parameters) for the design as a whole. In some embodiments, the specific field values of individual voxels within the design may be provided as a result of the operational simulation.

The procedure 1200 then advances to an end block and returns control to its caller.

FIG. 13 is a flowchart that illustrates a non-limiting example embodiment of a procedure 1300 for determining effective permittivity values for a voxel according to various aspects of the present disclosure. As discussed above, the procedure 1300 leverages the geometric shape primitives used to parameterize features within the design region to provide highly accurate values to be used in determining the effective permittivity values. The procedure 1300 assumes that a feature having a perimeter that passes through the voxel has been identified, and that the set of feature parameter values for the feature have been provided to the procedure 1300 along with coordinates of the voxel.

From a start block, the procedure 1300 advances to block 1302, where the set of feature parameter values and coordinates of the voxel are used to calculate a volume fraction of a first material and a second material in the voxel. In some embodiments, the volume fraction is determined using simple geometric calculations to determine the relative sizes of the first material and the second material in the voxel (e.g., the sizes of first material 1108 and second material 1106 in the voxel 1114 illustrated in FIG. 11B). Because the exact definition of the feature is available and used in this calculation, the precise relative sizes of the first material and the second material can be used, thus avoiding error introduced by simplifying the calculation to be based on the chord of the intersecting points of the feature and the voxel.

Smoothing can be performed by determining an effective tensor \tilde{ε} (or \tilde{μ}) which uses the arithmetic mean for fields parallel to the interface between the first material and the second material, and the harmonic mean for fields perpendicular to the interface between the first material and the second material. As described by Farjadpour et al., “Improving accuracy by subpixel smoothing in the finite-difference time domain,” Optics Letters Vol. 31, No. 20, Oct. 15, 2006, the entire disclosure of which is hereby incorporated by reference herein for all purposes, the smoothing can be represented as:

$${\tilde{ε}}^{- 1} = P < {ε}^{- 1} > + ( 1 - P ) < ε {>}^{- 1}$$

where P is the projection matrix Pᵢⱼ=nᵢnⱼ onto the normal [symbol] . The < . . . > denotes an average over the voxel sΔx×sΔy×sΔz surrounding the grid point in question, where s is a smoothing diameter in units of the grid spacing.

Accordingly, at block 1304, a smoothed permittivity matrix is generated for the voxel that includes a harmonic mean of a permittivity value of the first material and a permittivity value of the second material, and having an arithmetic mean of the permittivity value of the first material and the permittivity value of the second material. At block 1306, the set of feature parameter values and the coordinates of the voxel are used to calculate a surface normal vector and a surface tangent vector within the voxel.

At block 1308, a rotation of the surface normal vector and the surface tangent vector is calculated to generate a projection matrix. In some embodiments, the surface normal vector and the surface tangent vector are rotated only in two dimensions, since the features are assumed to be extruded along the z-axis. In some embodiments, the projection matrix may include rotations in all three dimensions, if the shape of features is modeled in the z-axis as well.

At block 1310, the smoothed permittivity matrix is multiplied by the projection matrix to generate the effective permittivity values for the voxel. One will recognize that an effective permittivity value is generated for each of the individual field components of the voxel.

The procedure 1300 then advances to an end block and returns control to its caller. Using the effective permittivity values for the voxel instead of the constant permittivity values of the first material and the second material allows the accuracy of the simulation to be increased as described above.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A non-transitory computer-readable medium having computer-executable instructions stored thereon that, in response to execution by one or more processors of a computing system, cause the computing system to perform actions for simulating performance of a physical device, the actions comprising:
configuring, by the computing system, voxels of a simulated environment to be representative of a set of structural parameters, wherein the set of structural parameters includes a set of features of a first material in an area of a second material, and wherein each feature of the set of features is parameterized by a set of feature parameter values; and
performing, by the computing system, an operational simulation of the physical device by calculating a plurality of time steps;
wherein calculating a current time step includes, for each voxel of the simulated environment:
concurrently with loading, by the computing system, a set of field values for the voxel for a previous time step from a main memory:
determining, by the computing system, permittivity values for the voxel using the feature parameter values;
calculating, by the computing system, a set of field values for the voxel for the current time step based on the set of field values for the voxel for the previous time step and the permittivity values; and
storing, by the computing system, the set of field values for the voxel for the current time step in the main memory;
wherein each set of feature parameter values includes a number of features that is smaller than a number of field values in the set of field values for the voxel for the previous time step.

2. The non-transitory computer-readable medium of claim 1, wherein the actions further comprise, for each voxel of the simulated environment, determining whether a perimeter of a feature passes through the voxel, wherein the perimeter of the feature indicates a boundary between the first material and the second material.

3. The non-transitory computer-readable medium of claim 2, wherein determining permittivity values for the voxel includes, for at least one voxel through which a perimeter of a feature passes, determining a set of effective permittivity values for the voxel, wherein determining the set of effective permittivity values for the voxel includes:
retrieving the set of feature parameter values for the feature having the perimeter that passes through the voxel; and
calculating the set of effective permittivity values for the voxel based on the set of feature parameter values.

4. The non-transitory computer-readable medium of claim 3, wherein each feature of the set of features is a circle, wherein each set of feature parameter values includes a radius value and a set of center coordinate values, and wherein calculating the set of effective permittivity values for the voxel based on the set of feature parameter values includes calculating the set of effective permittivity values for the voxel based on the radius value and the set of center coordinate values.

5. The non-transitory computer-readable medium of claim 3, wherein each feature of the set of features is an ellipse;
wherein each set of feature parameter values includes a set of focus coordinate values, a major axis size value, and a minor axis size value; and
wherein calculating the set of effective permittivity values for the voxel based on the set of feature parameter values includes calculating the set of effective permittivity values for the voxel based on the set of focus coordinate values, the major axis size value, and the minor axis size value.

6. The non-transitory computer-readable medium of claim 3, wherein each feature of the set of features is represented by one or more splines;
wherein each spline is represented by a set of feature parameter values that includes a set of knot vector values and a set of coefficient values; and
wherein calculating the set of effective permittivity values for the voxel based on the set of feature parameter values includes calculating the set of effective permittivity values for the voxel based on the set of knot vector values and the set of coefficient values.

7. The non-transitory computer-readable medium of claim 3, wherein calculating the current time step includes processing the voxels of the simulated environment in an order such that a plurality of voxels associated with each feature are processed consecutively.

8. The non-transitory computer-readable medium of claim 7, wherein retrieving the set of feature parameter values from the memory of the computing system includes:
in response to determining that the feature parameter values are present in a cache memory, retrieving the feature parameter values from the cache memory;
in response to determining that the feature parameter values are not present in the cache memory, loading the feature parameter values from the main memory.

9. The non-transitory computer-readable medium of claim 3, wherein determining the set of effective permittivity values includes:
calculating a volume fraction for the first material and the second material in the voxel based on the feature parameter values;
determining a smoothed permittivity matrix using a harmonic mean and an arithmetic mean of a permittivity value for the first material and a permittivity value of the second material based on the volume fraction;
determining a surface normal vector and a surface tangent vector based on the feature parameter values;
determining a projection matrix based on the surface normal vector and the surface tangent vector; and
multiplying the smoothed permittivity matrix by the projection matrix to generate the effective permittivity values for individual field components of the voxel.

10. The non-transitory computer-readable medium of claim 1, wherein the actions further comprise optimizing the set of structural parameters by:
determining a performance loss value based on a result of the operational simulation;
determining a structural gradient based on the performance loss value;
updating the structural parameters based on the structural gradient; and
repeating the operational simulation and the optimizing of the structural parameters to generate an optimized design.

11. A computer-implemented method for simulating performance of a physical device, the method comprising:
configuring, by a computing system, voxels of a simulated environment to be representative of a set of structural parameters, wherein the set of structural parameters includes a set of features of a first material in an area of a second material, and wherein each feature of the set of features is parameterized by a set of feature parameter values; and
performing, by the computing system, an operational simulation of the physical device by calculating a plurality of time steps;
wherein calculating a current time step includes, for each voxel of the simulated environment:
concurrently with loading, by the computing system, a set of field values for the voxel for a previous time step from a main memory:
determining, by the computing system, permittivity values for the voxel using the feature parameter values;
calculating, by the computing system, a set of field values for the voxel for the current time step based on the set of field values for the voxel for the previous time step and the permittivity values; and
storing, by the computing system, the set of field values for the voxel for the current time step in the main memory;
wherein each set of feature parameter values includes a number of features that is smaller than a number of field values in the set of field values for the voxel for the previous time step.

12. The method of claim 11, further comprising, for each voxel of the simulated environment, determining whether a perimeter of a feature passes through the voxel, wherein the perimeter of the feature indicates a boundary between the first material and the second material.

13. The method of claim 12, wherein determining permittivity values for the voxel includes, for at least one voxel through which a perimeter of a feature passes, determining a set of effective permittivity values for the voxel, wherein determining the set of effective permittivity values for the voxel includes:
retrieving the set of feature parameter values for the feature having the perimeter that passes through the voxel; and
calculating the set of effective permittivity values for the voxel based on the set of feature parameter values.

14. The method of claim 13, wherein each feature of the set of features is a circle, wherein each set of feature parameter values includes a radius value and a set of center coordinate values, and wherein calculating the set of effective permittivity values for the voxel based on the set of feature parameter values includes calculating the set of effective permittivity values for the voxel based on the radius value and the set of center coordinate values.

15. The method of claim 13, wherein each feature of the set of features is an ellipse;
wherein each set of feature parameter values includes a set of focus coordinate values, a major axis size value, and a minor axis size value; and
wherein calculating the set of effective permittivity values for the voxel based on the set of feature parameter values includes calculating the set of effective permittivity values for the voxel based on the set of focus coordinate values, the major axis size value, and the minor axis size value.

16. The method of claim 13, wherein each feature of the set of features is represented by one or more splines;
wherein each spline is represented by a set of feature parameter values that includes a set of knot vector values and a set of coefficient values; and
wherein calculating the set of effective permittivity values for the voxel based on the set of feature parameter values includes calculating the set of effective permittivity values for the voxel based on the set of knot vector values and the set of coefficient values.

17. The method of claim 13, wherein calculating the current time step includes processing the voxels of the simulated environment in an order such that a plurality of voxels associated with each feature are processed consecutively.

18. The method of claim 17, wherein retrieving the set of feature parameter values from the memory of the computing system includes:
in response to determining that the feature parameter values are present in a cache memory, retrieving the feature parameter values from the cache memory;
in response to determining that the feature parameter values are not present in the cache memory, loading the feature parameter values from the main memory.

19. The method of claim 13, wherein determining the set of effective permittivity values includes:
calculating a volume fraction for the first material and the second material in the voxel based on the feature parameter values;
determining a smoothed permittivity matrix using a harmonic mean and an arithmetic mean of a permittivity value for the first material and a permittivity value of the second material based on the volume fraction;
determining a surface normal vector and a surface tangent vector based on the feature parameter values;
determining a projection matrix based on the surface normal vector and the surface tangent vector; and
multiplying the smoothed permittivity matrix by the projection matrix to generate the effective permittivity values for individual field components of the voxel.

20. The method of claim 11, further comprising optimizing the set of structural parameters by:
determining a performance loss value based on a result of the operational simulation;
determining a structural gradient based on the performance loss value;
updating the structural parameters based on the structural gradient; and
repeating the operational simulation and the optimizing of the structural parameters to generate an optimized design.
